(19) United States
(12) Patent Application Publication
(10) Pub. No.: US 2025/0345714 A1
(43) Pub. Date: Nov. 13, 2025

(54) INTERACTIVE AI TOY CAPABLE OF HOLDING A CONVERSATION WITH A PERSON, AND METHOD OF INTERACTING WITH SAME

(71) Applicant: FRIENDLYBUZZ COMPANY, PBC, Surfside, FL (US)

(72) Inventors: Meier Marelus, Antwerp (BE); Myriam Harroch, Antwerp (BE); Levi Marelus, Antwerp (BE); Michael Marelus, Antwerp (BE); Gila Chacham, Berchem (BE)

(21) Appl. No.: 18/660,163

(22) Filed: May 9, 2024

(51) Int. Cl. A63H 3/28; A63H 3/02; G10L 13/02; G10L 15/18; G10L 15/183; G10L 15/22

(52) U.S. Cl. CPC A63H 3/28; G10L 15/1822; G10L 15/183; G10L 15/22; A63H 3/02; A63H 2200/00; G10L 13/02

(57) ABSTRACT

An interactive AI toy capable of holding a spoken conversation with a person. The toy can include any of a microphone configured for detecting a voice utterance of the person, a speaker configured for outputting a sound to the person, at least one processor configured for executing computer instructions, and at least one memory. The at least one memory can store computer instructions configured for operating the toy to perform steps comprising providing at least one machine learning (ML) model configured for generating contextually relevant and varied responses in natural language conversations. The steps can also include detecting a voice utterance of the person using the microphone, providing the voice utterance as an input to the ML model, prompting the ML model to generate an output based on the input, and providing the output to the speaker to be output to the person.

### TECHNICAL FIELD

The present disclosure relates generally to interactive AI toys. Particular embodiments relate to an interactive AI toy capable of holding a conversation with a person, and to a method of interacting with same, as well as a corresponding computer program.

### BACKGROUND

A toy is typically an object for a child to play with, typically a model or miniature replica of something, or sometimes an object, especially a gadget or machine, regarded as providing amusement for an adult. Interactive toys, i.e. toys, for (in particular) children, containing some form of interactive functionality allowing some forms of input from and output to the child are known, however their interactive functionality is limited.

Typical interactive toys are dedicated systems built around the basic form factor of a toy, such as a cuddly soft toy or a tough plastic toy, and may comprise a speaker, in order to play music or respond auditorily to the child. Of course, in the instances where the child's input is to be provided via voice, the toy may also comprise a microphone.

Traditionally, such toys typically operate through the usage of a button, the pulling of a string, the turning of a turn-key, the saying of a specific predetermined word or statement, or similar, whereby when the child would press the button, pull the string, turn the key, say the predetermined word, or similar, the toy would then react. To the extent a toy can react through audio, it would play a pre-recorded word or sentence (e.g. “I love you!”), pre-recorded song, or pre-recorded story (e.g. “Once upon a time . . . ”) or other message. However, traditional interactive toys face several limitations that impede user experience and functionality.

Traditional interactive toys can fall into three buckets: (i) traditional interactive toys that are not interactive, (ii) traditional interactive toys that are interactive, insofar as they include, for example, sensory effects (e.g. the toy can be touched, and in response to the touch the toy may play a song or a sound), yet with no user audio input capabilities for the purposes of interaction, and (iii) traditional interactive toys that include such audio input capabilities.

Most traditional interactive toys fall into category (i) above and are not interactive at all. Some traditional interactive toys fall within the category (ii) above, and have some form of interactivity with users, yet have no audio input capabilities for such purposes. Few traditional interactive toys fall within category (iii), and have audio input capabilities used for some forms of interactivity with users-however, these traditional interactive toys and their interactivities powered by said inputs are severely limited and suffer from immense shortcomings.

One prevalent challenge is the issue of conversational capacity. Traditional interactive toys, even with audio input capabilities, cannot interact in free-flowing conversation with the user. They are limited to predetermined responses to predetermined inputs. Traditional interactive toys cannot respond to input that does not reflect any predetermined and preprogrammed set of input. As such, they are unable to hold a conversation with users. Further, traditional interactive toys do not have any contextual understanding. As they follow a rigid set of preprogrammed instructions, reacting to limited predefined inputs, with specific and limited predefined outputs, traditional interactive toys have limited contextual understanding. Further, as traditional interactive toys do not have true conversational capacity, they are also unable to have rich conversational memory (e.g. what did the user eat yesterday or what homework did the user complete last week). Further, traditional interactive toys do not have any conversational coherence. Additionally, if a user says a sentence that the toy has not been programmed with, the toy is unable to respond to that sentence in an optimal manner (e.g. it might just respond with an error message or ask the user to try again in a pre-programmed message). Additionally, if a user only says half of the predefined input, traditional interactive toys are unable to provide the response. Further, with no capacity for free flowing conversation and related context and memory, traditional interactive toys are unable to adapt or be fully personalized to the user on the basis of such; traditional interactive toys cannot take into account the wishes, needs, desires, goals, or any other data of users which have been gleaned from its conversations with the user to personalize the interactions of the toy towards the user. Further, traditional interactive toys are thus also unable to provide any personalized support, whether physical, mental, emotional, or educational to the child, beyond the predetermined and preprogrammed limited outputs initially programmed. Furthermore, if one would want to expand the capabilities of existing rudimentary interactive toys to make it more interactive, one would need to pre program a significant amount of utterances the user may make, in all its different forms, which requires significant effort—and additionally would need to be recreated for every relevant language. In short, traditional interactive toys are designed to operate to only a rudimentary level of interaction.

Furthermore, privacy and security concerns have garnered increased attention in the realm of AI technology, raising apprehensions regarding the inadvertent recording and transmission of private conversations, all the more so in the context of children who are young and may be extra vulnerable psychologically. Addressing these concerns is useful for fostering trust and improving the widespread adoption of interactive toys.

In light of these challenges, there is a growing demand for innovative solutions that enhance the functionality, reliability, and security of interactive toys.

### SUMMARY

Novel approaches integrating advancements in AI, contextual understanding, privacy-preserving techniques, and interoperability standards hold the potential to redefine the capabilities of interactive toys and drive the next wave of innovation.

It is in particular an aim for various embodiments according to the present disclosure to bring conversation capability to toys of a type that is so far only rudimentarily interactive. In this context, a conversation may be understood to refer to an exchange, formal or informal, between two or more entities, in which information or ideas are exchanged, typically verbally, and preferably where neither the input nor the output are rigidly pre-programmed.

Accordingly, there is provided in a first aspect of the present disclosure an interactive AI toy capable of holding a spoken conversation with a person. The toy comprises the following components:
at least one microphone configured for detecting a voice utterance of the person;
at least one speaker configured for outputting a sound to the person;
at least one processor configured for executing computer instructions; and
at least one memory.

The at least one memory stores computer instructions configured for operating the toy to perform the following steps:
providing at least one machine learning, ML, model configured for generating contextually relevant and varied responses in natural language conversations;
detecting a voice utterance of the person using the at least one microphone;
providing the voice utterance as an input to the at least one ML model;
prompting the at least one ML model to generate an output based on the input; and
providing the output to the at least one speaker to be output to the person.

The at least one ML model may be provided by:
loading the at least one ML model into the at least one memory from a storage medium storing the at least one ML model; and/or
connecting via an optional communication connection of the toy with a server providing a conversation interface to the at least one ML model.

In other words, in this context, the expression ‘providing at least one ML model’ may be taken to refer to ensuring that the at least one ML model can be somehow accessed, interfaced with, and/or interacted with, or is loaded (i.e. a representation of the at least one ML model is digitally represented in the at least one memory) and thus available for access, interfacing and/or interaction.

In this context, the expression ‘detecting a voice utterance using the at least one microphone’ may be taken to refer to the process wherein the at least one microphone transforms a voice (i.e. an auditory sound) from an environment (typically ambient air, although underwater microphones can also be considered) into a recording, i.e. a preferably electronic representation of the voice utterance, which can—in principle—be played back again or analyzed. In other words, the term ‘detecting a voice utterance using the at least one microphone’ may be taken to relate to recording, registering, capturing, sensing, etc.

In this context, the expression ‘providing the voice utterance as an input to the at least one ML model’ may be taken to refer to the process wherein the toy is configured to ensure that the voice utterance is offered to the at least one ML model as an input for that/those ML model/models. Of course, one or more suitable transformations may be performed in order to transform the voice utterance into a form that is suitable for input into the at least one ML model, as the skilled person will appreciate and as will be further detailed below. In other words, the term ‘providing’ may in this context be taken to relate to inputting, coupling signals to each other, etc.

In this context, the expression ‘prompting the at least one ML model to generate an output based on the input’ may be taken to refer to the process of using the at least one ML model to infer an output (which is what every ML model produces) based on the provided input (which is what every ML model takes in order to produce its inferred output). In other words, the term ‘prompting’ may be taken to relate to inferring, activating, running, using, etc. It will be understood that the output (or outputs) of the at least one ML model may take many forms, including (but not limited to) textual, auditory, visual or multimodal (e.g. a combination of textual and visual or a combination of visual and auditory), and optionally including metadata along with the basic output (e.g. metadata describing a voice profile to be used for some output text, or metadata describing a discourse tone (e.g. ironic, stern, happy, suggestive, . . . ) to be used for some output text, or metadata describing a content maturity indication for some output).

In this context, the expression ‘providing the output to the at least one speaker to be output to the person’ may be taken to refer to the process of playing back the output to the person, or otherwise making the output perceivable by the auditory sense of the person.

In other words, the toy disclosed herein is an interactive AI toy which comprises a speaker and a microphone, as further described herein, and crucially also comprises or provides access to at least one especially configured ML model which renders the toy capable of holding conversations, because the at least one ML model has been especially configured for generating contextually relevant and varied responses in natural language conversations.

The context for which the responses may be relevant may be seen as the input and preferably also information obtained previously about the user and/or preferably general information that is true, such as the current time and/or the current location.

As noted, most traditional interactive toys are not interactive at all. Further, those traditional interactive toys that are interactive, their interactivity is limited. Toys that only enable non-voice-enabled interactivity (e.g. where the user cannot communicate with the toy through voice), are inherently limited. Toys that do contain a microphone and allow for voice-enabled interactivity are also limited, due to such toys being based on some form of predefined rigid trigger-response mappings (e.g. the well-known Furby toy which allows its users to state a few predefined words, which trigger pre-programmed responses). These traditional interactive toys are toys of only rudimentary interactivity, and thus when comparing the interactive AI toy disclosed herein to traditional interactive toys, the skilled person will appreciate that the interactive AI toy disclosed herein does not suffer from a legacy weight and other disadvantages of predefined rigid trigger-response mappings of traditional interactive toys.

Long-felt shortcomings of traditional interactive toys can be overcome, namely the shortcoming that they operate according to predefined rigid trigger-response mappings, which is a rigid and limited type of logic, and which does not support conversation capability, contextual understanding, nor conversational memory, which are all significant drawbacks of traditional interactive toys. Predefined rigid trigger-response mappings do not suffice to strike, maintain, hold, or drive conversations (which may collectively be called “holding” a conversation), because of their limited nature, due to the fact that predefined rigid trigger-response mappings are predefined, i.e. pre-programmed, and therefore such a traditional interactive toy can only operate according to and within a narrowly defined specific technical profile, based on bounded intents.

Further, as for predefined rigid trigger-response mappings, if one were to seek to expand their capabilities by pre-programming a much wider range of input/output possibilities, this would require immense labor in thinking of, preparing, and programming a significant list of possible utterances as input, and similarly output. Also, it is noted, that such programming would require programming in all languages the toy wants to interact in.

Another advantage of using an ML model, preferably a LLM, to generate the conversation is that, whilst a predefined rigid trigger-response mappings would not be able to handle a truncated user instruction due to the limitation of its pre-programming, the ML model can. Whilst predefined rigid trigger-response mappings cannot handle incomplete sentences (as an incomplete sentence would generally not match to a predefined instruction), a ML model, preferably an LLM, has no such limitations. If a truncated input is provided, the LLM can analyze it, handle it; and it may ask a clarifying question, or preferably a relevant clarifying question, if needed, or it can understand the input from its context or otherwise, and either way still continue a conversation in a human-like and smooth manner.

Conversation-capable ML models, such as Large Language Models, LLMs can advantageously be used in order to introduce conversation capabilities into the domain of interactive toys, for conversations via voice input and output. This can also help the toy reach a level of trust, intimacy, and experience for the user which would not be possible otherwise.

In addition, in comparison to prior art interactive toys, which are characterized by their use of, and reliance on, predefined rigid trigger-response mappings (where such interactivity goes beyond non-voice enabled interactivity-after all, as described above, most traditional interactive toys are not interactive at all, and some have some forms of limited non-voice enabled interactivity such as sensory effects or push-to-play buttons, whilst the types of toys that have some form of voice-enabled interactivity are suffering from the immense limitations of predefined rigid trigger-response mappings and as such), the limitations of traditional interactive toys can be overcome by using conversation-capable ML models, which endows the interactive AI toy according to the present disclosure with conversation capabilities.

Furthermore, comparing the interactive AI toy according to the present disclosure to notoriously known Sci-Fi toys alleged to offer conversation capability, the skilled person will appreciate that these Sci-Fi toys did and do not actually offer conversation capability but were only described fictively (or scripted) to seem to do so, because no conversation-capable AI component existed yet. Therefore, the skilled person has so far understood that those Sci-Fi toys were fictional and not technical, and thus do not form prior art.

ML models, such as Large Language Models, LLMs can advantageously be used in order to actually (i.e. in real engineering practice) provide conversation-capable interactive AI toys, for conversations via voice input and output.

We note that it is a drawback of conventional written conversations that the user needs to produce (e.g. type) a textual representation of his or her thoughts and then needs to confirm that this textual representation can be input to an LLM, because both of these steps take time and artificially interrupt the conversation.

Comparing the interactive AI toy according to the present disclosure to a smartphone coupled with an LLM-driven interface, the skilled person will appreciate that the smartphone coupled with the LLM-driven interface is very clearly not what one would consider a toy. Further, it may require that voice input has to be activated on the smartphone (which increases user friction, in addition to time lag), can require that input is confirmed by pushing a (physical or virtual) button (which is cumbersome), and generally presents a virgin instance of the underlying LLM (which is not always helpful for the user's goals).

It is noted, in general, that the interactive AI toy may be configured (e.g. by containing in the at least one memory computer instructions for) so to cause proactive interactivity or assistance, i.e. interactivity or assistance which are not a response to a direct user query, but which is triggered by, for example, a predicted or surmised potential user query or user need, user desire, even when this query, or need, or desire is latent or implicit, or unspoken.

In a preferred embodiment, the interactive AI toy lacks predefined rigid trigger-response mappings (wherein the term predefined rigid trigger-response mappings is defined herein, e.g. lists of possible utterances matched to output need not be pre-programmed). In this context, the term ‘lack’ may be taken to refer to being free from, not including, missing, not being limited by, etc.

In a preferred embodiment, the at least one ML model comprises:
a Natural Language Understanding, NLU, module for parsing a user input;
a Context Management, CM, module for maintaining a conversation context; and
a Generative Language, GL, module for producing coherent responses based on the input and the context.

Preferably, the CM module may be configured to receive any or all previous conversations between the system and the person.

Said previous conversations may preferably be associated with at least one metadata tag identifying at least one topic of each respective previous conversation.

Preferably, the interactive AI toy according to the present disclosure comprises one or more filtering units configured to analyze the output intended to be provided to the at least one user and further configured to block or adapt said intended output based on a predefined set of filtering criteria (e.g. profanity filtering). Similarly, the interactive AI toy according to the present disclosure may comprise one or more filtering units configured to analyze at least the input from the user, and further configured to block or adapt said input based on a predefined set of filtering criteria. In a preferred further-developed embodiment, the at least one memory of the toy may further store computer instructions configured to cause the toy to produce a default answer (e.g. “Come again, please?”) if the filtering unit were to block an output or an input, and if this were to lead to time latency or hiccups in the conversation, or for any other reason. Further, at least one ML model may assist with each or all of the above.

In a preferred embodiment, the toy is configured to detect whether or not a suitable and authentic physical token is present, in order to unlock at least one toy function for one or more users.

Preferably, this detection may be activated after, or even only after, the user has activated it (temporarily or permanently), in order to save battery, e.g. by saying “look, I've bought this new figurine”, or if the detection mechanism is triggered via a mechanical trigger.

In a further-developed preferred embodiment, the toy comprises at least one input element configured to receive (e.g. by inserting, touching, or approaching) the physical token, such as a figurine or a toy card.

Preferably, the toy may comprise a camera configured to visually detect the physical token.

In a further-developed preferred embodiment, the toy comprises a wireless communication interface configured to detect a presence of and/or a distance to a corresponding wireless communication element contained in the at least one physical token to be received.

In a preferred embodiment, the toy comprises a wireless communication interface configured to establish a connection to a top-up server; wherein the computer instructions are further configured for operating the toy to perform the following steps:
receiving from the top-up server a verified indication indicating at least one toy function to be unlocked for one or more users; and
unlocking the indicated at least one toy function.

For example, the user may buy the function on a supplier's website, and the supplier may then use his top-up server to send a corresponding verified indication to the user's toy. In another example, the user may buy the function via a companion app, which may then trigger a remote top-up server, or may even act as a top-up server itself, to send a corresponding verified indication to the user's toy.

In a preferred embodiment, the computer instructions are further configured for operating the toy to perform the following steps:
upon activation of the toy, entering a wake-word detection state, wherein the toy is configured for detecting a predetermined wake-word or any predetermined wake-word of a predefined plurality of predetermined wake-words in ambient sound recorded by the at least one microphone;
if the predetermined wake-word is detected, setting the toy to enter an active state wherein the toy is configured for detecting the voice utterance until the toy enters the wake-word detection state again; and
after a predetermined cooldown time duration has passed since the conversation or after satisfying an activity maintenance condition, setting the toy to enter the wake-word detection state again.

As an example of a cooldown time duration, the toy can be configured to enter the wake-word detection state again after a certain number of frames have passed with no (relevant) voice activity, subsequent to completion of the toy's sound output.

As an example of an activity maintenance condition, the toy can be so configured to enter the wake-word detection state again right after the toy has determined that a user's input has ended (e.g. this can require the user to say a wake-word again in follow-on input in a multi-turn conversation, and such follow-on use of a wake-word may be the same as the initial wake-word (e.g. hey Rea) or a different wake-word more suitable in follow-on conversation (e.g. thanks Rea; got it Rea; okay Rea)).

Because the toy may stay in the active state until it enters the wake-word detection state again, once the user has spoken the wake-word, the toy may keep on listening (until some halting condition is reached, preferably a predetermined cooldown time duration has passed after the end of the conversation), without requiring the user to keep on repeating the wake-word at every single utterance of a multi-turn conversation. Also in case of a single-turn conversation, wherein the user and the toy exchange only one utterance/output each, this clear delineation of states helps so that the user can finish his or her utterance completely before the toy (ostensibly) reacts (noting that the toy may of course react internally and transparently to the user, based on the user's voice utterance). This is especially beneficial in case the user cannot formulate utterances swiftly. Advantageously, the toy may be configured to store the cooldown time duration as a user-accessible setting, allowing the user to increase or decrease the cooldown time duration, to accommodate very slow speakers or to facilitate very fast speakers.

In a preferred embodiment of the above-described system, the system is configured to, in the active state, detect the (or another, e.g. “Stop, Rea”) wake-word, and to initialize a new conversation with the same or with a different user. In either case (i.e. with the same or with a different user), the system may be configured to either end the ongoing conversation or continue the ongoing conversation. This may be performed in a single-user setting and/or in a multi-user setting.

In a further embodiment, the toy may comprise a pressable button, and the computer instructions are further configured for operating the toy to perform the following steps:
upon activation of the toy, entering a button-press detection state, wherein the toy is configured for detecting a button-press action by the person pressing on the pressable button;
if the button-press action is detected, setting the toy to enter an active state wherein the toy is configured for detecting the voice utterance until the toy enters the button-press detection state again; and
after a predetermined cooldown time duration has passed since the conversation or after satisfying an activity maintenance condition, setting the toy to enter the button-press detection state again.

For the avoidance of doubt, in an embodiment, the toy may be configured to use both a wake word and a button press, or just one of them in different situations (e.g. button press to initiate conversation and wake-word to continue conversation).

Because the toy can stay in the active state until it enters the button-press detection state again, once the user has pressed the pressable button (thus performing a button-press action), the toy can keep on waiting (until some halting condition is reached, preferably a predetermined cooldown time duration has passed after the end of the conversation), without requiring the user to keep on repeating the button press action at every single utterance of a multi-turn conversation. Also in case of a single-turn conversation, wherein the user and the toy exchange only one utterance/output each, this clear delineation of states may help the user finish his or her utterance completely before the toy (ostensibly) reacts (noting that the toy may of course react internally and transparently to the user, based on the user's voice utterance). This is especially beneficial in case the user cannot formulate utterances swiftly. Advantageously, the toy may be configured to store the cooldown time duration as a user-accessible setting, allowing the user to increase or decrease the cooldown time duration, to accommodate very slow speakers or to facilitate very fast speakers.

In a further-preferred embodiment of the above-described toy, the toy is configured to, in the active state, detect the button-press action, and to initialize a new conversation with the same or with a different user. In either case (i.e. with the same or with a different user), the toy may be configured to either end the ongoing conversation or continue the ongoing conversation. This may be performed in a single-user setting and/or in a multi-user setting.

As an example of a cooldown time duration, the toy can be so configured to enter the button-press detection state again after a certain number of frames have passed with no (relevant) voice activity, subsequent to completion of the toy's sound output.

As an example of an activity maintenance condition, the toy can be so configured to enter the button-press detection again right after the toy has determined that a user's input has ended (e.g. this can require the user to button press again in follow-on input in a multi-turn conversation).

For the avoidance of doubt, the toy may be configured to use both a wake word and a button press, or just one of them in different situations (e.g. button press to initiate conversation and wake word to continue conversation).

In a preferred embodiment, the stored computer instructions may be further configured for operating the toy to perform the following pre-processing step, after detecting the voice utterance:
transforming the voice utterance into a textual representation using a speech-to-text engine; wherein the step of providing uses the textual representation of the voice utterance.

In a preferred embodiment, the toy is configured for pre-prompting the at least one ML model based on a predefined or dynamic pre-prompting instruction.

In this context, a pre-prompting instruction may be predefined in the sense that it has been statically set up by a supplier or the user, or may be dynamic in the sense that it learns from experience.

In a preferred embodiment, the stored computer instructions may be further configured for operating the toy to perform the following post-processing step, prior to providing the output to the at least one speaker:
transforming the output from a textual representation to a sound format using a text-to-speech engine.

In a preferred embodiment, the computer instructions are further configured for operating the toy to perform the following steps:
when detecting the voice utterance, determining a first probability that a further sound detected by the at least one microphone comprises a further voice utterance and determining a second probability that the further sound comprises an ambient noise sound; and
if the first probability is higher than the second probability, continuing the current step of detecting the voice utterance; and
if the second probability is higher than the first probability, ending the current step of detecting the voice utterance.

In a preferred embodiment, the computer instructions are further configured for operating the toy to perform the following step:
detecting voice activity in sound detected by the at least one microphone, based on at least one of: a time duration exceeding at least one predetermined corresponding threshold; and a speech detection level exceeding at least one predetermined corresponding threshold.

In a preferred embodiment, the computer instructions are further configured for operating the toy to perform the following step:
after detecting the voice utterance and before providing the generated output to the at least one speaker, generating a filler output based on the detected voice utterance, using a constrained processing budget in order to generate the filler output within a constrained time duration adapted to seek to be less than the time duration until the generated output can be provided to the at least one speaker;
deciding whether to output the filler output to the at least one speaker (e.g. whether or not it will in fact reduce perceived latency e.g. on the basis of the expected time the other output is expected) and
if decided to output, outputting the filler output to the at least one speaker.

In a preferred embodiment, the computer instructions are further configured for operating the toy to perform the following step:
recognizing an identity of the person based on the detected voice utterance; and
providing the recognized identity as an additional input to the at least one ML model.

In a preferred embodiment, the computer instructions are further configured for operating the toy to perform the following steps:
while the voice utterance is being detected, dividing the voice utterance in a plurality of units;
while the voice utterance is being detected and as soon as each unit of the plurality of units is available, providing said unit as an individual input to the at least one ML model; and
prompting the at least one ML model to generate the output based on the multiple individual inputs.

Optionally, the units of the plurality of units may be divided from each other in a semantically coherent way, in order to optimize the probability that the at least one ML model can produce a semantically relevant response. Additionally or alternatively, the units of the plurality of units may be divided from each other based on a time-based cutoff scheme, e.g. cutting off parts every 1000 ms, or cutting off parts every time a silence of at least 500 ms is detected, or something similar. This has the benefit of more straightforward processing at the toy's end (i.e. where the voice utterance is transformed into a form suitable for input into the at least one ML model), and spreads out the processing requirements at the at least one ML model's end.

In order to determine a semantically coherent division, the system may be configured (e.g. by containing in the at least one memory computer instructions for) to causing basic fast natural language processing techniques, or an ML model, to may be utilized, e.g. fast parsers that detect when certain types of phrases are formed, e.g. noun phrases (e.g. “the green light in the room”) or verb phrases (e.g. “she gave that to us”) even if there is a probability that the person might utter further words belonging to the same overall sentence or commencing a new sentence.

In a further-developed embodiment, the computer instructions are further configured for operating the toy to perform the following steps:
obtaining from the at least one ML model multiple individual outputs whether or not corresponding respectively with the multiple individual inputs; and
combining the multiple individual outputs into a semantically coherent whole output to be provided to the least one speaker as the output.

In a preferred embodiment, the at least one speaker is configured for outputting sounds with voice-quality fidelity over a full frequency range of human hearing.

Preferably, the speaker is configured for outputting sounds over a range of 12 Hz to 28 kHz, preferably 20 Hz to 20 kHz, more preferably to 15 kHz, most preferably 2 kHz to 5 kHz.

In a preferred embodiment, the at least one microphone is configured for recording sounds with voice-quality fidelity over a full frequency range of a normal human voice.

Preferably, the microphone is configured for recording sounds over at least a range of 90 Hz to 300 Hz, preferably over a range of around 90 Hz to around 1000 Hz, in order to capture as much nuance of the person's voice as possible, regardless of the person's sex or age.

While not required, there may be multiple microphones and these may be configured for far field capture (e.g. laid out in an array).

In another preferred embodiment, the toy may be further adapted in the sense that the at least one ML model has been trained with a corpus predominantly comprising dialogue (real or synthetic) between at least two parties, wherein at least one party of said at least two parties is a child, or has otherwise been trained, fine-tuned, prompted, instructed or otherwise configured (e.g. to conduct conversation in a manner better suitable for a conversation with a child, or to adopt the character of a princess of certain children's book).

In another embodiment, it is preferable that the microphone is configured for recording sounds up to a higher frequency range, including 300 Hz, in order to better be able to capture children's relatively higher voices.

In further developed embodiment it may be preferred to form the interactive AI toy in any shape of a toy (e.g. action hero, robot, truck, etc.; and may e.g. be fluffy, rigid, etc.).

Additionally, there is provided in a second aspect of the present disclosure a computer-implemented method of interacting with the toy of any one of the disclosed embodiments, for holding a conversation with a person. The method comprises:
providing at least one machine learning, ML, model configured for generating contextually relevant and varied responses in natural language conversations, by:
loading the at least one ML model into the at least one memory from an optional storage medium storing the at least one ML model; and/or
connecting via an optional communication connection of the toy with a server providing a conversation interface to the at least one ML model;
detecting a voice utterance of the person using the at least one microphone of the toy;
providing the voice utterance as an input to the at least one ML model;
prompting the at least one ML model to generate an output based on the input; and
outputting the output to the person using the at least one speaker of the toy.

In a preferred embodiment, the at least one ML model comprises:
a Natural Language Understanding, NLU, module for parsing a user input;
a Context Management, CM, module for maintaining a conversation context; and
a Generative Language, GL, module for producing coherent responses based on the input and the context.

Preferably, the CM module is configured to receive any or all previous conversations between the system and the person.

In a preferred embodiment, the method comprises detecting whether or not a suitable and authentic physical token is present, in order to unlock at least one toy function for one or more users.

In a preferred embodiment, the toy comprises at least one input element configured to receive the physical token, such as a figurine or a toy card.

In a preferred embodiment, the toy comprises a wireless communication interface configured to detect a presence of and/or a distance to a corresponding wireless communication element contained in the at least one physical token to be received.

In a preferred embodiment, the toy comprises a wireless communication interface configured to establish a connection to a top-up server; the method comprising the following steps:
receiving from the top-up server a verified indication indicating at least one toy function to be unlocked for one or more users; and
unlocking the indicated at least one toy function.

In a preferred embodiment, the method comprises the following steps:
upon activation of the toy, entering a wake-word detection state, wherein the toy is configured for detecting a predetermined wake-word or any predetermined wake-word of a predefined plurality of predetermined wake-words in ambient sound recorded by the at least one microphone;
if the predetermined wake-word is detected, setting the toy to enter an active state wherein the toy is configured for detecting the voice utterance until the toy enters the wake-word detection state again; and
after a predetermined cooldown time duration has passed since the conversation or satisfying an activity maintenance condition, setting the toy to enter the wake-word detection state again.

In a preferred embodiment, the toy comprises a pressable button, the method comprising the following steps:
upon activation of the toy, entering a button-press detection state, wherein the toy is configured for detecting a button-press action by the person pressing on the pressable button;
if the button-press action is detected, setting the toy to enter an active state wherein the toy is configured for detecting the voice utterance until the toy enters the button-press detection state again; and
after a predetermined cooldown time duration has passed since the conversation or satisfying an activity maintenance condition, setting the toy to enter the button-press detection state again.

In a preferred embodiment, the method comprises the following pre-processing step, after detecting the voice utterance:
transforming the voice utterance into a textual representation using a speech-to-text engine; wherein the step of providing uses the textual representation of the voice utterance.

In a preferred embodiment, the method comprises pre-prompting the at least one ML model based on a predefined or dynamic pre-prompting instruction.

In a preferred embodiment, the method comprises the following post-processing step, prior to providing the output to the at least one speaker:
transforming the output from a textual representation to a sound format using a text-to-speech engine.

In a preferred embodiment, the method comprises the following steps:
when detecting the voice utterance, determining a first probability that a further sound detected by the at least one microphone comprises a further voice utterance and determining a second probability that the further sound comprises an ambient noise sound; and
if the first probability is higher than the second probability, continuing the current step of detecting the voice utterance; and
if the second probability is higher than the first probability, ending the current step of detecting the voice utterance.

In a preferred embodiment, the method comprises the following step:
detecting voice activity in sound detected by the at least one microphone, based on at least one of: a time duration exceeding at least one predetermined corresponding threshold; and a speech detection level exceeding at least one predetermined corresponding threshold.

In a preferred embodiment, the method comprises the following step:
after detecting the voice utterance and before providing the generated output to the at least one speaker, generating a filler output based on the detected voice utterance, using a constrained processing budget in order to seek to generate the filler output within a constrained time duration adapted to be less than the time duration until the generated output can be provided to the at least one speaker;
deciding whether to output the filler output to the at least one speaker (e.g. whether or not it will in fact reduce perceived latency e.g. on the basis of the expected time the other output is expected) and
if decided to output, outputting the filler output to the at least one speaker.

In a preferred embodiment, the method comprises the following step:
recognizing an identity of the person based on the detected voice utterance; and
providing the recognized identity as an additional input to the at least one ML model.

In a preferred embodiment, the method comprises the following steps:
while the voice utterance is being detected, dividing the voice utterance in a plurality of units;
while the voice utterance is being detected and as soon as each unit of the plurality of units is available, providing said unit as an individual input to the at least one ML model; and
prompting the at least one ML model to generate the output based on the multiple individual inputs.

In a preferred embodiment, the method comprises the following steps:
obtaining from the at least one ML model multiple individual outputs corresponding respectively with the multiple individual inputs; and
combining the multiple individual outputs into a semantically coherent whole output to be provided to the least one speaker as the output.

In a preferred embodiment, the at least one speaker is configured for outputting sounds with voice-quality fidelity over a full frequency range of human hearing.

In a preferred embodiment, the at least one microphone is configured for recording sounds with voice-quality fidelity over a full frequency range of a normal human voice.

In another preferred embodiment, the method is further adapted in the sense that the at least one ML model has been trained with a corpus predominantly comprising dialogue (real or synthetic) between at least two parties, wherein at least one party of said at least two parties is a child, or has otherwise been trained, fine-tuned, prompted, instructed or otherwise configured (e.g. to conduct conversation in a manner better suitable for a conversation with a child, or to adopt the character of a princess of certain children's book).

Additionally, there is provided in a third aspect of the present disclosure a computer program comprising instructions which, when the program is executed by a computer, cause the computer to carry out the method of any one of the above-described embodiments.

A computer-readable storage medium comprising instructions which, when executed by a computer, cause the computer to carry out the method of any one of the above-described embodiments.

A data processing apparatus comprising means for carrying out the method of any one of the above-described embodiments.

It will be appreciated by the skilled person that various considerations and advantages applicable to certain embodiments (e.g. embodiments of the toy) may also be applicable to other embodiments (e.g. embodiments of the method), mutatis mutandis and vice versa.

The embodiments described herein are provided for illustrative purposes and should not be construed as limiting the scope of the invention. It is to be understood that the invention encompasses other embodiments and variations that are within the scope of the appended claims. The invention is not restricted to the specific configurations, arrangements, and features described herein. The invention has wide applicability and should not be limited to the specific examples provided. The embodiments disclosed are merely exemplary, and the skilled person will appreciate that various modifications and alternative designs can be made without departing from the scope of the invention.

### BRIEF DESCRIPTION OF THE DRAWINGS

In the following description, a number of exemplary embodiments will be described in more detail, to further help understanding, with reference to the appended drawings, in which:

FIG. 1A schematically illustrates an exemplary embodiment of an interactive AI toy according to the present disclosure, with a casing adapted to a fluffy toy;

FIG. 1B schematically illustrates another exemplary embodiment of an interactive AI toy according to the present disclosure, with a casing adapted to an action figure toy, such as a robot;

FIG. 2 schematically illustrates an exemplary embodiment of an interactive AI toy according to the present disclosure, which may for example be configured to perform the exemplary method embodiment of FIG. 3;

FIG. 3 schematically illustrates a computer-implemented method according to the present disclosure, which may for example be performed using the exemplary toy embodiment of FIG. 2;

FIG. 4 schematically illustrates two exemplary embodiments of an interactive AI toy according to the present disclosure;

FIG. 5 schematically illustrates an exemplary embodiment of a method according to the present disclosure, which may for example be a further development of the exemplary method embodiment of FIG. 3;

FIG. 6 schematically illustrates several options (A, B and C) of how to provide the voice utterance as input to the at least one ML model in the context of various embodiments according to the present disclosure;

FIG. 7 schematically illustrates several options of transforming the voice utterance into a textual representation (FIGS. 7A and 7B) and several options of providing the voice utterances (in their textual form) as input to the at least one ML model (FIGS. 7C and 7D);

FIG. 8 schematically illustrates an example of using pre-rendered high-quality audio fragments in order to more quickly generate output sound from a TTS engine;

FIG. 9 schematically illustrates an example of harmonizing several pre-rendered high-quality audio fragments with each other and with newly generated audio fragments, in order to quickly generate output sound from a TTS engine;

FIG. 10A schematically illustrates an embodiment of the toy according to the present disclosure, in a first setup;

FIG. 10B schematically illustrates the embodiment of FIG. 10A, in another setup;

FIG. 11 schematically illustrates a setup involving a so-called conductor tasked with arranging and guiding a conversation; and

FIG. 12 schematically illustrates a setup wherein multiple users may be holding one or more conversations with the at least one ML model.

### DETAILED DESCRIPTION

As indicated above, it is an aim for various embodiments according to the present disclosure to bring human-like natural-like conversation capability to interactive toys.

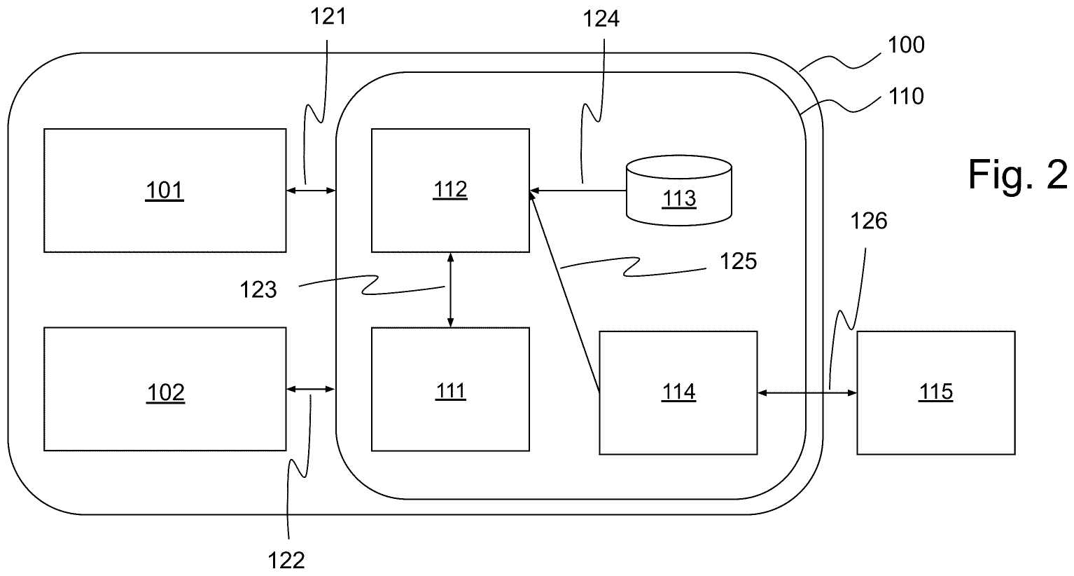

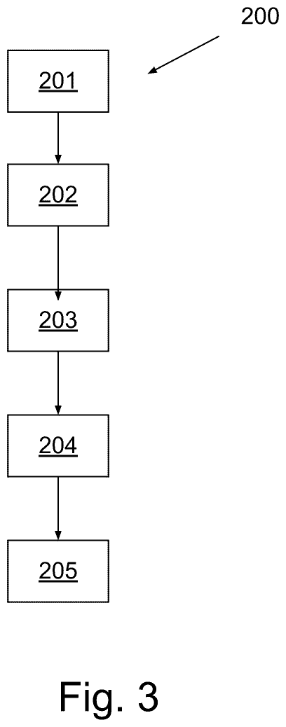

FIG. 2 schematically illustrates an exemplary embodiment of an interactive AI toy 100 according to the present disclosure, which may for example be configured to perform the exemplary method embodiment 200 of FIG. 3, but which may of course for example be configured for other, one or more, more specific method embodiments according to the present disclosure.

The interactive AI toy 100 may be suitable for holding a spoken conversation with a person (the person is not shown in the figure). The toy may further be configured so as to be able to, in addition to holding a conversation, to also, for example, drive a conversation, or start a conversation, or make conversation, or perform a mixture of these, or other forms of conversation, depending on context, suitability, configuration, or otherwise. The toy 100 may comprise the following components: at least one microphone 101, at least one speaker 102, at least one processor 111, and at least one memory 112.

The at least one microphone 101 may be configured for detecting a voice utterance of the person. The skilled person will understand that any suitable microphone or microphones may be used for this purpose, as long as it is/they are in general capable of detecting, i.e. capturing, sounds within the normal voice range for humans.

The at least one speaker 102 may be configured for outputting a sound to the person. The skilled person will understand that any suitable speaker or speakers may be used for this purpose, as long as it is/they are in general capable of outputting, i.e. playing, sounds within the normal voice range for humans.

In various further developed embodiments, the at least one speaker 102 may be configured for outputting sounds with voice-quality fidelity over a full frequency range of human hearing.

Preferably, the at least one speaker comprises a loudspeaker configured for outputting sound according to the following criteria, in order to achieve human voice-like output:
The loudspeaker should have a frequency response range from 80 Hz to 260 Hz to cover the full vocal range of both adult males and females.
The frequency response should be relatively flat within this range, with variations of no more than ±3 dB to ±6 dB across the spectrum.
Total harmonic distortion (THD) should be kept low, ideally below 1% across the frequency range.
Intermodulation distortion (IMD) should also be minimal, typically below 0.5%.
The loudspeaker should have a fast transient response to accurately reproduce the quick changes in amplitude and frequency characteristic of human speech. This can be measured using parameters such as rise time, settling time, and step response.
The loudspeaker should have a balanced frequency response, meaning that it should not exhibit significant peaks or dips in its frequency response, ensuring a natural and accurate reproduction of voice frequencies, and any deviations from flat response should be minimal and well-controlled.
The loudspeaker should be able to handle sufficient power to produce adequate sound levels without distortion.

Nevertheless, it is to be understood that embodiments featuring a less-developed or even a more-developed speaker than the above preferred exemplary loudspeaker are still to be considered to be within the scope of the present disclosure.

In particular, and advantageously, for an interactive toy according to the present disclosure, as an example, it may be preferred to include a less-developed speaker, because toys typically suffer from rough handling, and because many toys are more often associated with less high quality sound output.

Similarly, the microphone and/or other elements may be less-developed, better-developed or of a different nature, considering for example that if the toy is to be used as a handheld toy close to a child's face, for example, that the voice input will likely be close to the toy.

Preferably, the toy 100 may include a component comprising one or more communication connectivity interfaces, such as Wi-Fi (IEEE 802.11), Apple AirPlay 2, USB-C line-in, Bluetooth, etc. This may allow, for example, a user to connect their smartphone device to the toy 100. This may allow for example, a user to stream music and control such streaming from a separate system, for example a smartphone device, to be played through the toy's at least one speaker 102, or enable, for example, voice telephone conversations through the toy 100.

Preferably, the toy 100 may have at least, but need not have, two of its perpendicular three-dimensional dimensions within a range of about 1 cm to about 20 or 25 cm, in order to inter alia be able of generating a sufficiently powerful sound output, whilst also being sufficiently easily visible for ease of operation and sufficiently hefty to ensure safe handling.

The at least one processor 111 may be configured for executing computer instructions, as will be explained below. The at least one memory 112 may be storing computer instructions configured for operating the toy 100 to perform the following steps, but need not be limited to these (cf. FIG. 3):
providing 201 at least one machine learning, ML, model configured for generating contextually relevant and varied responses in natural language conversations;
detecting 202 a voice utterance of the person using the at least one microphone 101;
providing 203 the voice utterance as an input to the at least one ML model;
prompting 204 the at least one ML model to generate an output based on the input; and
providing 205 the output to the at least one speaker 102 to be output to the person.

To this end, the at least one microphone 101 and the at least one speaker 102 may be connected 121, 122 to the ensemble 110 of the at least one processor 101 and the at least one memory 112.

The at least one ML model may for example be one single Large Language Model, LLM (or a Small Language Model, SLM, or some other language model, and for the avoidance of doubt, such terms are used interchangeably herein). Such LLMs may be formed of private models or open models such as LLaMA2, or both. In addition, any such models may be fine-tuned, tweaked, prompted, adapted, or otherwise customized or configured. In an alternative example, the at least one ML model may be a set of multiple LLMs, configured to interoperate. In yet another example, the at least one ML model may comprise one or more LLM models and in addition, or separate, thereto may comprise one or more other types of models, preferably language models, more preferably one or more text-to-speech, TTS, and/or speech-to-text, STT, image-to-text, ITT, speech-or-text-to-image, speech-or-text-to-video, and/or multi-modal or other models (all of which terms are used interchangeably herein). In addition, any such models can work concurrently, may know of each other and their respective roles, and/or work interoperably.

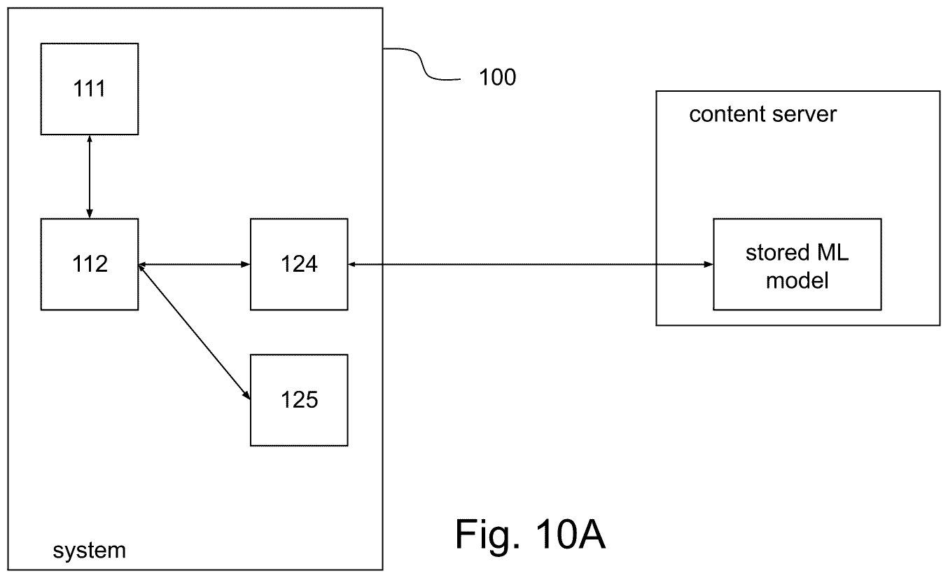

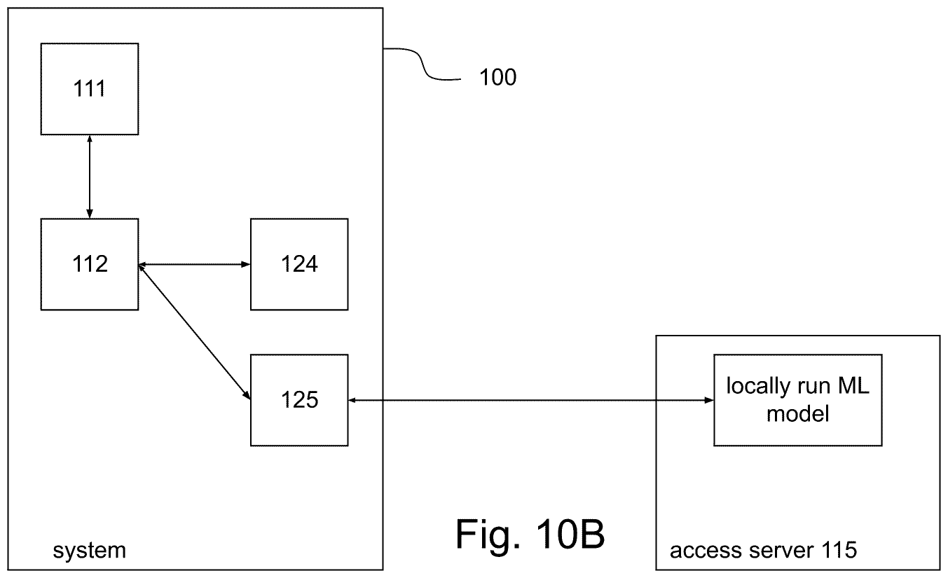

The at least one ML model may preferably be provided 201 by:
loading the at least one ML model into the at least one memory 112 from a storage medium 113 storing the at least one ML model (e.g. via pathway 124), as is also illustrated as a schematic example in FIG. 10A, where the storage medium is (in this example) remote from the toy 100; and/or
connecting (e.g. via pathway 125) via an optional communication connection 114 of the toy 100 with a server 115 providing a conversation interface 126 to the at least one ML model, as is also illustrated as a schematic example in FIG. 10B, where the at least one ML model is run locally at a remote access server 115.

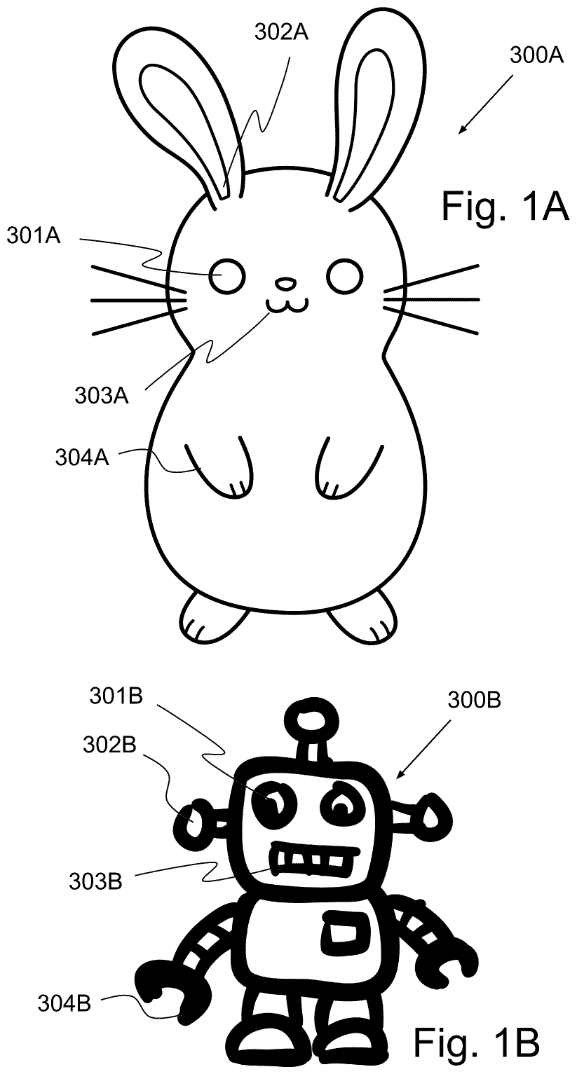

Referring to the examples of FIGS. 1 and 2 and to the example of FIGS. 10A and 10B, the step of providing 201 the at least one ML may, as discussed hereinabove and hereinbelow, may involve (in other words) getting a local copy of the ML model(s), and/or getting online interface access to a copy of the ML model(s) stored (and executable) on another computer.

When the at least one ML model is stored locally (cf. FIG. 10A), the step of providing 203 the voice utterance as an input to the at least one ML model and the step of prompting 204 the at least one ML model to generate an output based on the input, may comprise offering the voice utterance as input to the locally stored ML model(s) and inferring from (an execution of) the locally stored ML model(s) an inference that corresponds with the input.

Additionally or alternatively, conversely, when the at least one ML model is stored (and executable) on another computer 115 (cf. FIG. 10B), the step of providing 203 the voice utterance as an input to the at least one ML model and the step of prompting 204 the at least one ML model to generate an output based on the input, may comprise sending the voice utterance as a data message via the interface 126 to the remote server 115 in order to supply the voice utterance as input to the offsite ML model(s), and in order to trigger the offsite ML model(s) to infer an inference that corresponds with the input. Of course, the inference may then be provided from the server 115 to the toy 100 as another data message.

The at least one memory may optionally further store computer instructions configured for detecting, for example, a wake-word, for noise cancellation, for acoustic echo cancellation, for beamforming, for speaker recognition, and/or for detecting voice activity, in order for example to detect when a user input is complete and ready to be processed, and/or any other instructions or any other purpose.

Given current cost realities and current developments on the one hand, and currently foreseen developments on the other hand, the skilled person will appreciate that the at least one ML model may currently be made available to the toy via the communication connection with the server if the at least one ML model is too large or too slow or too expensive to fit onto the at least one memory and/or run on the processor of the toy locally, but that it is entirely foreseen and is in fact currently technically possible but, at least for LLMs with a large number of parameters, financially relatively expensive (in light of hardware requirements) to make the at least one ML model available locally on the at least one memory of the toy and/or run on one or more of its processors. Furthermore, it is currently technically possible but financially relatively expensive to provide the storage medium initially storing the at least one ML model, particularly an LLM with a large number of parameters, locally on the toy, however this is possible and the toy may have one or more ML models running on-system. In this context, the storage medium may be taken to refer to one or more long-term memory storages storing a fixed or initial instance of the at least one ML model, and the at least one memory may be taken to include one or more short-term memories configured to allow computational operations by a processor in order to interact with the at least one ML model once that is loaded in those one or more short-term memories.

As discussed above, the toy 100 may be a toy which comprises not only a speaker and microphone, but also comprises or provides access to at least one especially configured ML model which renders the voice-powered toy capable of holding conversations, because the at least one ML model has been especially configured for generating contextually relevant and varied responses in natural language conversations.

The toy can therefore participate, and even stimulate, conversations that are multi-turn, personalized, adaptable, context-aware, and supported by natural human-like memory (as described further herein), and sound natural (i.e. human sounding output) all without requiring any pre-programmed rigid scripts and/or related predefined rigid trigger-response mappings.

Therefore, and as explained further herein, comparing this voice-powered interactive toy to traditional interactive toys, the skilled person will appreciate that the interactive AI toy revealed herein (i) enables the toy and its user(s) to participate in free-flowing multi-turn conversation, which is something traditional toys are incapable of doing, (iii) allows such conversation to be natural, personalized and adaptable, and (iii) does not suffer from a legacy weight of predefined rigid trigger-response mappings of traditional interactive toys.

Predefined rigid trigger-response mapping is the underpinning logic of traditional interactive toys that aim to understand a user's input and serve as some form of limited interaction with the user (e.g. when a user says “I Love You”, upon which Furby will respond with a preprogrammed same, or user says “Dance Party”, and Furby will play some preprogrammed sounds and blink its eyes).

The idea of predefined rigid trigger-response mapping is to map or reduce the user's utterances to pre-determined and pre-labelled instructions (e.g. “Furby, Let's Dance”) and related output (e.g. Furby plays preprogrammed sounds and blinks its eyes). Obviously, because the instructions to which this mapping operation are predefined, they are limited.

There is, additionally, a risk of mismatch between the user's actual wish and the wish that the traditional interactive toy identifies and, if the user's utterance does not map to the pre-programmed instructions, the toy will be unable to understand what the user wants and hence will fail to conduct the requested activity.

Further, traditional interactive toys cannot interact in free flowing conversation with the user. They are limited to predetermined responses to predetermined inputs. Traditional interactive toys cannot respond to input that does not reflect any predetermined and preprogrammed set of input. As such, they are unable to hold a conversation with a user(s) (e.g. as it is impossible to foresee and pre-program the magnitude—and indeed infinity—of possibilities in multi-turn dialogues). Further, traditional toys do not have any rich contextual understanding. As they follow a rigid set of preprogrammed instructions, reacting to limited predefined inputs, with specific and limited predefined outputs, traditional toys have no rich contextual understanding. Further, as traditional toys do not have any free-flowing conversational capacity, they are also unable to have any rich conversational memory (e.g. what did the user eat yesterday or what homework did the user complete last week). Further, traditional toys do not have any conversational coherence. Additionally, if a user says a sentence that the traditional interactive toy has not been programmed with, the traditional interactive toy is unable to respond to that sentence in an optimal manner (e.g. it may respond with an error message or ask the user to try again). Additionally, if a user only says half of the predefined input, traditional interactive toys are generally unable to provide the response. Further, with no capacity for free-flowing conversation or memory, traditional interactive toys are unable to adapt or be fully personalized to the user; traditional interactive toys cannot take into account the wishes, needs, desires, goals, or similar, whether past or present, or any other data, of users which have been gleaned from its conversations with the user to personalize the interactions of the toy towards the user. Further, traditional toys are thus also unable to provide any support, whether physical, mental, emotional, or educational to the child, beyond the predetermined and preprogrammed limited outputs initially programmed. Furthermore, if one would want to expand the capabilities of such a toy to make it more interactive, one would need to pre program a significant amount of utterances the user may make, in all its different forms, which can require significant effort—and additionally would need to be recreated for every relevant language. In short, traditional interactive toys are designed to operate to only a rudimentary level of interaction. Additionally, embodiments revealed herein cannot be implemented with traditional rudimentary interactive toys.

The newly available generation of conversation-capable ML models, such as Large Language Models (LLMs), can advantageously be used in order to introduce conversation capabilities to toys, for conversations via voice input and output. This understanding opens up an entirely new array of use cases and applications for interactive toys according to the present disclosure, because this gives these toys significant usefulness, variation, fluidity and expressive power.

Additionally, as part of the backend process, a “state decider” functionality can be provided. Such a functionality may be provided by an ML model, such as an LLM, or some other way, which may be prompted or otherwise trained or fine-tuned or instructed in a certain manner, and which may be configured to decide whether, in order to provide an adequate response to the user's input, the toy ought to obtain the response solely from an LLM, whether to obtain additional data from a database, such as for example through a RAG system (which is well-documented to the skilled person), through a system configured for browsing the web and for retrieving information, through accessing a proprietary knowledge base, through accessing and retrieving information from an RSS, or any other system, method or data, and/or to trigger any other applications, systems, methods or data, Additionally, the state decider may be configured to determine whether to involve another ML model, including an LLM, and if so which ML model(s).

The toy may additionally comprise a memory that may serve to enrich its conversations with the user. Such a memory may comprise (suitable representations of) all, parts, summarized parts or otherwise annotated parts of previous conversations between the toy and the user, which may also for example, be ranked between newer and older conversations as well as other ranking methods (e.g. importance). The full message history, of both input and output, may be recorded in a database or elsewhere, and may be embedded (e.g. given the text a numerical representation in a vector space). It may be provided to the at least one ML model, preferably an LLM, through its context window as part of its prompting (i.e. the history or part of the history may be added into the context window as part of its prompting, thereby giving the LLM the conversation history and giving it “memory”) or it may be filtered in advance and only parts of the history provided (e.g. relevant topic history only, or relevant category history only) for example through the ranking of results via another LLM or through a different or another method.) Additionally, a RAG process, as described further herein, or other retrieval processes may be used to retrieve any relevant history and feed such history to the at least one ML model through its prompting.

Additionally, a same or a separate ML model, preferably an LLM, may be invoked to determine which memories to include and which not to include. Additionally, some memories may be prioritized over others, depending, for example, on the user, user background, user interest, user needs, and/or on user preference and/or ranking.

Additionally, for example, and in order to, for example, overcome the need to include large amounts of history transcription in the context window, an ML model, preferably an LLM, may be instructed to from time to time summarize or otherwise process certain conversation history. Such summaries can then be included in the context window, whether by default, or, as part of, or after, a RAG or other selection or retrieval process.

Additionally, one or more ML models, preferably an LLM, can serve as one or more filter screening units of input and/or output, to determine whether the user input is something its instructions allow it to pass and whether it complies with set terms of use, and/or another policy or guardrail, for example a profanity filter appropriate for children. Similarly, it may review the proposed toy's output prior to delivering the output. The toy can also be set so that, in case of a blocker by a filter screen, it automatically plays back a certain response (whether personalized or not) to the user.

Additionally, we may have a same ML model or a separate one, preferably an LLM, label, number, and/or otherwise categorize some or all conversation history, and other in-putted knowledge (see below), as part of, or separate to, any RAG, for various reasons, including to improve accuracy, and to reduce latency, and similar.

All ML models can but need not run concurrently (i.e. at least seemingly at the same time in the experience of the user).

Similarly, the toy may know certain facts or information about the user or related to the user. Such facts may similarly be provided to the ML model (by the user, admin, family, friends, teachers, doctors, and the like, through mobile app, web app, email, text, voice straight to the toy, APIs, etc.) so as to allow the toy to have personalized conversations.

Preferably, each user may experience a personalized experience with the toy. As the toy's responses are not rigidly pre-programmed, unlike traditional rudimentary interactive toys, the ML model can be prompted, instructed, trained or otherwise formed to take on a certain character, behave a certain way and the like. This means that the toy may (i) adapt to the user, and (ii) the user may tweak the experience. As an example of the first, the toy can engage on topics the toy knows the user enjoys talking about and stay away from topics that the user engages less in. As an example of the latter, a user, or a third party, may, through an onboarding app or through voice-powered settings or some other way, request that the toy be, for example, of a certain religious belief and the toy will then assume such persona and reflect it accordingly in the conversations.

The persona of the toy may thus also demonstrate, where relevant and appropriate, any one or more of the whole gamut of human emotions, whether in tone, context, word-usage, or similar. Further, like a human, it may also provide support, encouragement, and positivity, or similar, where relevant and appropriate, to the user.

Further, in another embodiment, the toy may be used for holding a conversation (e.g. about any topic including for example current events, the time, the weather, sports) but also be able to provide additional experiences and assist the child, by having the toy be connected to or otherwise be able to provide additional services (e.g. play music, play radio, call a person, send a text, etc.). The toy may thus also be used for obtaining guidance on and for arranging solutions for practical problems of the user, e.g. homework support, connecting with a home tutor, etc. Further, the toy, with its context and memory knowledge (e.g. memory described herein), as well as possible camera or other embodiments, may recommend any of the above to the user, and may as well arrange the support necessary. For example, user: “You won't believe it; I did really bad on my math exam.”, toy: “Oh no. Shall I arrange for a private tutor to give your mom a call?”, and the toy may, where appropriate, arrange said support via for example API connectivity, integrated text messages, or otherwise (such as for example by triggering an automated notice to a tutoring service provider, that includes a description of the issue and the phone number & address of the relevant user, allowing the tutoring service to contact the user's parents or guardian to schedule a visit, or for example automatically assist user with the homework issues it is facing). The support necessary may of course be provided by third parties with whom partnerships have been established, internal services of a supplier, or via family members and/or caregivers, amongst others.

In various embodiments, in addition to the toy being capable of participating in free-flowing multi-turn conversations, the toy may be configured to use function calling or other method (to connect the one or more ML models, and preferably an LLM, to another tool such as an application), to additionally provide the user with a better experience, or to undertake tasks on behalf of a user such as for example to play music or update a calendar. The ML model, and preferably an LLM, will for example conclude whether the request made (e.g. update calendar) requires the assistance of, for example, an app (e.g. calendar app), and if so, then automatically undertakes relevant actions (e.g. sending instructions relevant to the app).

Another advantage of using an ML model, preferably an LLM, to generate the conversation is that, whilst a traditional interactive toy would not be able to handle a truncated user input due to the limitation of its predefined rigid trigger-response mappings, the ML model, preferably an LLM, has no such limitations. If a truncated input is provided, the LLM can analyze it: it may ask a clarifying question if needed, or it can understand the input from its context or otherwise, and either way continue a conversation in a human-like and smooth manner. Similarly, if the audio input from the user is not clear and cannot be transcribed correctly—for example because of a user's heavy accent—whilst a traditional interactive toy would struggle to match a partial/incomplete sentence with a predefined utterance covered by its predefined rigid trigger-response mapping, an ML model, preferably an LLM, can use full context and its knowledge to understand the input or otherwise can ask a clarifying question.

### Human-Like Conversation

As described herein, various embodiments of the toy according to the present disclosure can be programmed to sound and/or come across human-like when engaging with a person.

In addition to the use of one or more ML models, and preferably an LLM model, to generate responses to user input in a human-like manner, as discussed, various additional features may be useful for further improving the human-like quality of such conversation. As noted, the memory of past conversations and user data may further help to allow the toy to act human-like, with a natural memory.

As noted herein, a wake-word algorithm can be used to identify when a set wake-word has been said, triggering the toy to start processing user voice input. As elaborated on elsewhere herein, the wake-word is optional and there may be other methods of commencing interaction with the toy (such as for example a press to talk button, or for the toy to commence interaction with the user (i.e. proactive) when for example detecting close presence, etc.). There can be one wake word or numerous wake words, and individual wake words can be programmed differently (e.g. “help” as a wake-word, when uttered, triggers an emergency call).

To mimic human conversations, the toy can be so programmed so that no wake-word needs to be used. The toy can use data from its optional camera, for example, to sense whether the user is looking at the toy and can thus commence listening for user input (rather than listening all the time, as, even with a module to differentiate between noise and voice, the toy should ideally know whether it is random voice (e.g. conversation between the user and a visitor, for example) or whether it is voice directed to the toy). The toy may leverage a motion sensor or motion algorithm or some other manner to know when the user is in front of the toy and looking at the toy. It may for example snap a photo, and can do so continuously or from time to time, analyze whether the user is looking at the toy and, if so, then commence processing input without the need for a wake-word. Similarly, the toy may use bluetooth recognition, and/or bluetooth signaling, or Wi-Fi or similar signaling processes, to similarly commence processing input, or to provide pro-active output to the user, without requiring a user wake-word. Similarly, the toy may employ a voice activity detection module, and, optionally additionally or separately, snap a photo to analyze whether or not it looks like the user is addressing the toy. An ML model may be employed for both or either of these.

Using an ML model, preferably an LLM model, as set out herein, creates an additional need and opportunity for innovation in terms of determining when user input has ended, considering there is no pre-programmed list of all possible inputs. As such, solutions to determine when a user input has ended, as described herein, may be required. We also note as an aside, that additionally, the toy may include voice activity (e.g. end of utterance) detection algorithm that is trained on real and/or synthetic voice utterances (e.g. end of user sentences, inputs, etc.), to determine the likelihood that a user input is at the end of the user's input for the toy to then process.

Additionally, and this is something traditional interactive toys generally never needed to grapple with as they are incapable of engaging in free-flowing multi-turn conversations, is how to reduce friction in multi-turn conversations so as not to require the user to, at the start of every new input, use the wake word and/or otherwise notify or trigger the toy to know that the conversation has not ended and continues. If the toy simply assumes the conversation continues, it may likely risk picking up the user's voice even when the user is not directing their voice to the toy. However, requiring the user to use a wake word again, or to otherwise trigger the toy, may possibly increase friction, reduce the user experience, and/or be counterproductive for a conversational user experience.

As such, we may resolve these issues as follows, and may configure the system to function as follows: once the wake-word is detected, the toy may continue in conversation with the user without requiring the user to utter the wake-word every time it communicates with the toy during that conversation. The user and the toy can then engage in multi-turn conversation without the user needing to utter the wake-word throughout the conversation, after the initial utterance of the wake-word. Additionally, however, the toy needs to know when the conversation has ended, so that it for example stops actively listening (and e.g. transcribing etc.), as it may possibly otherwise pick up utterances that are not directed to the toy yet think it is a conversation with the toy and hence process the input (e.g. picking up conversation between children in a classroom). Therefore, we may employ a voice activity detection module that listens for user voice and which can be configured so as to pick up voice within a certain time period or other interval or condition even after the end of the toy's output. It may further be configured to enter regular listening mode if no voice is detected.

For the avoidance of doubt, references to wake-word herein, as appropriate and where appropriate elsewhere include where the toy is activated not by wake-word but through other means such as e.g. a press to talk button, motion detector, etc.

Further, a similar word recognition method, through wake-word preprogramming or otherwise (e.g. an LLM may be so configured for this), may be used for other reasons, such as for example, a user may wish to stop the toy from completing its response to the user (e.g. user: “Stop speaking”), or for purposes of the toy identifying or otherwise understanding that user would like to end the conversation (e.g. “Goodbye”), whereupon, for example the toy would stop the conversation.

One embodiment of a voice activity detection module is for example the following. A voice activity model is used, and an activity threshold is set, for example to 30% (i.e. the threshold at which the toy assumes the input is human voice). Additionally, audio input may be split into frames (e.g. set a sample rate and a frame size). Where this activity threshold is met, for a period of, for example, X number of frames, the toy considers said activity as speech, and is to process it. Where there is, for example, less than X frames that rise above said threshold, the toy is to consider said activity as non-speech and/or to delete and not process. Further, where the activity threshold is met for said X frames, the toy is to consider a silentframe threshold, i.e. a silent period of say Y frames, where, if no activity frames falls above the activity threshold of 30% above, the toy is to consider that the user has ended the user's input. These thresholds need not be fixed, and can be changed. An ML may assist with this, depending on the user, user habit, speech tendencies, speech requirements, or otherwise.

Further, in another embodiment, the voice activity detection may also include a base-line threshold, which would consider any activity that falls between the activity threshold and the base-line threshold as non-speech, with the baseline threshold also functioning as the silentframe threshold. Further, where a wake-word is used, or for example if a button, motion detection, face-detection, etc., is used, that insinuates or otherwise demonstrates that user intends to speak, the toy need not adhere to the above, for the first statement, as the toy may assume voice activity, but may be so programmed to still adhere to a silentframe threshold, or some other method (e.g. the user stopped looking at the toy for X number of frames, or the user pressed a button), so to know when the user stopped speaking.

Additionally, we can use an ML model, preferably an LLM model, to determine voice activity. The ML model can be programmed, prompted, instructed, trained or otherwise taught to determine whether or not the audio input is directed to the toy. If it determines that it is directed to the toy, then process. If it determines that it is not directed to the toy, then remove and ignore. Such a model can be employed with or without an additional voice activity detection module, or wake-word module, described above.

Similarly, the ML model which can pick up (all or some) voice and be programmed, prompted, instructed, trained or otherwise taught or configured to determine whether or not the audio is human voice, and preferable human voice directed to the toy, or background noise, conversation and/or other sound.

We note that these can all be used both for the first turn in a conversation when triggered by a user, and/or for subsequent turns within the same conversation, and/or in subsequent turns within a conversation where interaction was commenced by the system.

Additionally, an ML model, preferably an LLM model, may be employed and/or configured to determine whether or not, or the likelihood that its output will trigger the user to provide further input. For example, a separate ML model, preferably an LLM (or the same ML model, preferably an LLM model) can provide an analysis and respond to the toy with a, for example, Yes/No result on whether or not further user input is expected in the conversation. Where further input is expected, we can configure the toy to allow for a larger window of capturing user input without requiring the wake-word subsequent to the toy's output (e.g. wait X seconds in active listening mode for user input, and only re-employ the wake-word detection state if no input observed within X seconds), and a smaller window (or no window) where no further input is expected.

As such, an LLM model may but need not replace a wake-word detection module and or a voice activity detection module. Similarly, a ML model can be used to detect wake-words (either for example by transcribing all audio input and then identifying when the wake-word was said, or by additionally or separately using an LLM model to review the input.

These can also, in combination with user voice identification modules, be combined so that the toy is only listening to the voice of the pre-set user(s) or otherwise already-identified user(s) of the toy, further reducing the amount of voice input it may have to analyze and determine whether or not it is addressed to the toy.

In addition to improving the user experience, not using a wake-word may have an additional advantage that there is no continuous need to listen for a wake word, thus saving energy and extending the lifetime of the toy, in addition to any user experience benefits.

Similarly, we can allow a user to barge-in whilst the toy is still talking. A voice activity detection module can identify that there is new voice input and the toy can be so programmed to handle barge-in. For example, to differentiate between speech directed to the toy (barge-in) and other speech that may be occurring whilst the toy plays output, we can use similar solutions as those to the wake-word and its alternatives described herein (e.g. configure the toy to detect an utterance of a user or a wake-word (e.g. same wake-word as to activate device, or different wake-word (e.g. “stop”), which if detected whilst the system is providing output triggers the output to stop and new input to be recorded). Additionally, we can use a ML model, preferably a LLM, to analyze the input (e.g. text transcription) of the barge-in and decide whether the barge-in is directed to the toy and if so stop or otherwise amend the toy output and/or next part of the conversation.

Additionally, the ML model, preferably a LLM, can be so prompted, instructed, trained, tuned or otherwise taught or instructed to ask, when relevant and appropriate, clarifying questions. For example, if the toy is unsure whether or not the user is addressing the toy (e.g. because the module to determine so concludes that it is a borderline case), the toy can ask the user “Hey [Jack], are you talking to me?” to clarify.

Another advantage of using an ML model, preferably a LLM, to generate the conversation is that, whilst the traditional rudimentary interactive toy would not be able to handle a truncated user instruction due to the limitation of its pre-programming, the ML model can. If a truncated input is provided, the LLM can handle it and ask a clarifying question if needed, or understand the input from its context or otherwise, and still continue a conversation in a human-like manner.

One may also employ other steps to improve the user experience, including with regards to latency. Currently LLM models generally generate a response only once the full user input is submitted; one can add an ML model, preferably an LLM, that constantly reviews user input while it is ongoing (e.g. word by word, as the words are being processed), determines when it is likely that the user input has completed or otherwise determine when it believes it knows enough to process the input, for example in light of context or past conversations or other data, and immediately sends that to an LLM for processing. This would cut down on the last words of the user, if those are unnecessary for the LLM to understand what its output should be, during which the processes can be undertaken and a response provided faster. It can be combined with another module that ensures that the LLM response is not played to the user before the user has finished their input, even when the toy has “heard enough” to already provide a response.

As noted herein, one can also employ filler words to reduce the perception of latency.

The at least one ML model, preferably LLM, can be prompted, trained, taught, tuned or otherwise instructed or configured to sound human, with for example filler words and the like. Similarly, the TTS modules can be tuned or prompted to express human intonation, emotions, accents, etc., and TTS modules currently on the market indeed are able to express some human intonations, emotions, and accents. For example, one way of doing so is, for example, providing the TTS module with addition input (e.g. “Today, I went swimming.”—she said happily.”, and then removing and discarding the TTS output of the words “—she said happily.” whilst only using the output corresponding to “Today, I went swimming.”; such discarding can be done by for example, chunking the output appropriately.)

In order to reduce latency between user input and the toy output, one may want to program the toy so that any output of the ML model, preferably LLM, is provided token to token or streamed in some other manner to the toy. For example, an LLM providing text output should stream its output to the toy, for example, on a token by token basis, so that the output can immediately be further processed, such as for example, by sending the output to the TTS module or to some other ML model, such as for example a filtering model.

Additionally, one may want to chunk the text output received from the ML model, preferably LLM, and send those chunks to the TTS module, rather than waiting for the full text to be generated and only then sending the full text to the TTS module. When chunking text to send to a TTS module, in order to improve the intonations of the output of the TTS module, we may chunk at relevant punctuation (e.g. period, comma, question mark, exclamation mark) or in some other manner so, while not needing to wait for the whole text to be ready and sent in one go, so to still ensure the speech produced takes into account the punctuation and delivers human-like speech even when reducing latency and improving the user experience as such output can immediately be played to the user (even before the full text output has been generated into audio).

We may for example also chunk after a certain amount of tokens, or words (e.g. in case there is no punctuation before 10 words, we may want to chunk at 10 words). Further, any chunking may occur only at some parts of a conversation (e.g. only the first few words are to be chunked), and/or otherwise only until the first speech token has started playing to the user. Further, when chunking we may create a method that chunks only after full words, so that no chunking should occur mid-word. To do so, we may add for example, a chunking rule that can require the toy to chunk words for example only after a certain amount of tokens, and only prior to a word (or token) where there is an empty space token in front of it, indicating that the prior word is a full one. We may also use a separate LLM to create said chunking, which may additionally take into account, amongst other things, for example, context, prior sentences, words, and tokens, when doing so.

Further, the toy may, for example, use lower quality TTS for the first few words, so that these get back to the user much quicker, before then changing into higher quality TTS, where perceived latency is not as impacted. Similarly, the toy may use a quicker, yet lower quality STT, for a first few tokens, before changing into a slower, yet better quality STT, where perceived latency is not as impacted. Similarly, the same can be done at other relevant stages/aspects of output, such as where relevant text-to-video.

Further, one can optimize hardware to assist with latency.

Further, the one or more ML models may be provided with a background personality (e.g. an ML model may be called Tony, born in New York, moved to Texas at age 8, etc.) to give it a further human-like character and feel.

### Context Awareness

In order to, for example, streamline and/or improve or enrich such conversations, the at least one ML model may preferably be coupled with a Retrieval Augmented Generation, RAG, module configured for obtaining documents or other data (e.g. pre-stored local or cloud documents and/or live web search results) related, for example, to a particular conversation query, response, or user, and for taking those documents or other data into account when generating the output for the user. Additionally, and most preferably, the at least one ML model may be coupled with a database containing personal interests of the user, local information relevant to the user, contact details of the school or contacts of the user, etc. This database may comprise structured facts provided by e.g. the user, a parent or a family member or a teacher, or the child's social worker, prior to and/or during interactions with the toy, may comprise unstructured facts gleaned from earlier conversations with the user, as well as full conversation history between user(s) and toy. In this way, the toy may be adapted to hold human-like conversations with the user, that are further enriched with a personalized database(s).

In this way, the system can be provided with a Context Management, CM, module.

User information, including for example the full conversation history between the toy and the user(s) can be embedded, stored in a vector or similar database, and then form part of a RAG module. This can but need not complement a traditional keyword-based retrieval model. Additionally, a separate ranking step(s) can be introduced that compares and/or ranks results and determines which to include in the context for the ML model. Additionally, or separately, a reciprocal rank fusion module, with or without, for example, multi-query generation, can be implemented.

Additionally, the retrieval of data may include a process where it not only retrieves the relevant piece(s) of data but also includes relevant context (and/or surrounding pieces of data) of said piece of data to provide a more relevant and helpful piece of data. Additionally, as part of the information retrieval the toy may include a summarization of data and review and/or retrieve said summaries only, or additionally.

Additionally, the toy may also include categorizations and/or labels of pieces of data, whether a sentence paragraph, or a summary, or any other type of data, and provides it with a relevant label (e.g. food, sport, family) to the toy. An at least one ML model, and preferably an LLM model, may be used, prompted, instructed, or otherwise configured to conduct the summarization of the data and/or the labeling of the data. In addition, the label and categorizations may also denote the importance of a piece of data (e.g. whether important to the user, important for and/or to the toy and/or user purpose, for the purpose of more human-like, more relevant, and/or more smooth conversations), and may also include any other categorizations and/or labeling of data.

As for languages, and as noted, the predefined rigid trigger-response mappings are a barrier to offering different languages, as every possible utterance needs to be programmed in all languages the logic wants to handle. However, the disclosed interactive AI toy can easily be programmed to handle any language without the need to provide it with all possible user utterances and map those utterances to pre-defined intents. Rather, as long as the at least one ML model that can input and output one or more foreign languages, the toy can easily process input in the foreign language and output in the foreign language. Indeed, numerous STT, TTS and LLM models available today handle a plethora of foreign languages.

### Onboarding & User Experience

In order to seed the toy with such a personalized database(s), or simply to improve the user experience, the toy may be configured to use an onboarding process.

Such onboarding process can be through voice engagement with the toy (as the toy transcribes and can store data from audio input, and additionally can be prompted or otherwise instructed or trained to extract input from a user and to store such data). This is advantageous, as it allows, for example, for a toy to undertake a wholly human-like voice conversational onboarding process with the child. It can also be, for example through a web-app, smartphone app, by the user or a third party, data from the public domain, data obtained through connecting to APIs, through email, fax, uploaded photographs (which can but need not be processed to extract information such as from documents), etc. Similarly, such avenues can be used to modify or update information stored by the toy.

Uniquely, because the toy is voice-powered with at least one ML model, preferably an LLM, that can handle and process input, and additionally generate output that can be processed by other back-end applications, the toy can change user settings simply through voice, it can conduct user feedback and other surveys, including, for example, any school surveys, homework questionnaires, other questionnaires and tests, through voice, it can provide and engage with marketing messages by voice, and the like. Indeed, the entire or a large part of the toy user interface may be experienced and controlled by voice. Further, these onboardings, questionnaires, surveys, and marketing may be conducted through voice in a strict-to-follow order and content format. It may also be conducted more fluidly, through conversation, for example, where the order and/or the text of the onboarding, survey, or questionnaire, need not strictly be followed, and where the aim of the onboarding, survey questions, or questionnaires, for example, are, thereby reaching the goal of the survey, questionnaire and onboarding and obtaining the relevant responses to them through voice. Further, the system can undertake these forms of surveys, onboarding experiences, or the like on its own, with the toy only requiring, for example, the aim, goals, tone, purpose, and/or intents of the surveys, or for example with the system receiving certain administrative input as to what to look out for in user responses (e.g. accuracy of response, temperament of the user, etc.). These surveys, onboarding experiences, or the like may also be conducted using text-to-speech, speech-to-text, but also text-or-speech-to-video, for example.

Note that, additionally, different ML models, or the same ML models but with different prompts or instructions may be invoked at different, and/or same, times, and dynamically, with or without the user knowing that they are invoked. These can be invoked or triggered at certain times (e.g. a morning ML model instructed for a morning conversation routine for example when the child wakes up and gets ready for school) or at certain instances, or when certain input is obtained (e.g. a user asks for a sports update, for example, a dedicated ML model, or prompted model, may be invoked, or for example, if a user mentions that the user is not feeling so well (or if the toy otherwise understands the case to be so), a dedicated ML model, or prompted model, may be invoked). For example, as regards onboarding, a specific ML model, or the same ML model but with specific prompts may be invoked when a user first uses the toy, which then takes the user through an onboarding experience. As noted additionally herein, the behavior of the ML model(s) may (but need not be) be dynamic, adapting to the user, user preferences, conversation history and other factors.

Additionally or in the alternative, the toy can be so programmed or otherwise configured or set up to take on certain emotions, moods, health status, feelings, etc. and these may change from time to time, whether time based changes or triggered changes (e.g. triggered by input received from the user), and may also be randomized, or otherwise set up. In addition, such configuration may be through the prompting of a ML model, preferably an LLM model. Further, these may also be influenced or otherwise affected by user input. This too can be for example through direct user input (e.g. child telling the toy to be happy today or otherwise making the toy happy) or for example if the user is rude to the system, the toy can be upset, or if the user gives compliments the toy's mood can be happy, and which can be communicated or expressed in the toy's use of language, voice, tone, or any other way (e.g. on any display, if it has a display, or lighting, etc.). In another embodiment, the toy may mature over time (e.g. the way a human matures as they grow in terms of personality, language, speaking, temperament, and other skills).

### Various Further Embodiments

Below, various further developed exemplary embodiments will be described, featuring a variety of optional elements, which may be combined where appropriate.

The toy may comprise at least one communication interface, e.g. for Wi-Fi and/or Bluetooth. For any of the embodiments described in the present disclosure, a companion app may be provided for installation onto a computer system of a parent, teacher, family member, social worker, and/or other stakeholder, and that the at least one memory may comprise computer instructions configured for causing the toy to communicate via said at least one communication interface with said companion app. The companion app may be a smartphone app and/or a locally installed PC application and/or a remotely accessible online application.

Additionally, the toy and any related apps, may also be configured to communicate with any third party databases, whether, for example, via APIs or similar (e.g. with healthcare, GP, or other applications or databases).

The toy may comprise a mains connection configured to be connected to a mains power outlet. Additionally or alternatively, the toy may comprise a (preferably rechargeable) battery. In either case, the toy may comprise a driver configured to draw power supplied from the mains connection and/or supplied from the battery, and the driver may be configured to drive the electronics of the toy.

The toy may comprise a display, hologram, or a projector configured to display a visual representation, which can also be designed, for example, to correspond with the voice utterance output and/or input. The at least one memory of the toy may further store computer instructions configured to cause the toy to generate such a visual representation. This may for example be performed using a speech-to-image, speech-to-video, text-to-image and/or text-to-video engine.

Additionally, the toy may allow for a user (or e.g. teacher or home tutor) to upload a document (e.g. a set of math exercise), on the basis of which a text-to-video engine can, whether or not prompted or otherwise instructed, create a video related to that document (e.g. a video showing how the exercises should be completed). The toy may then demonstrate that video on the screen when the toy speaks with the user covering content that relates to the video and/or document, for example.

Video can also be generated in the moment, in light of the conversation. For example, it can generate a video demonstrating the way to solve a math problem in response to a user's query.

The toy may comprise one or more output lights, e.g. LED lights. These output lights may be configured for indicating a technical status or a virtual mood of the toy, for expressing emotions, or for other purposes. Additionally, for example, the toy may be capable of expressing emotions by changing the output on its screen (if it has a screen, as mentioned herein), its color of its eyes (if it has eyes), moving limbs (if it has limbs, as mentioned herein), through the use of words, through the tone of their voice (as part of the speech engine), or through any other manner.

The toy may comprise at least one motion sensor, configured for detecting for example presence or motion of a person. The toy may comprise other sensors, such as light, touch, and similar and other sensors.

The toy may comprise facial expression recognition (FER) and/or body detection, accelerometer(s), and sensors, including sensors configured for detecting, for example, the mood of a user, their demeanor, facial expressions, body movement (for example, when coaching a child with the exercise required by their PE class) etc.

Advantageously, the at least one memory of the toy may further store computer instructions configured to cause the toy to proactively initiate conversations with a person if the person is detected, or at certain scheduled times, or otherwise. Preferably, this may be achieved by introducing one or more default prompts into the at least one ML model, e.g. a default prompt like “Tell me something interesting.” or “Ask me a relevant and funny question.”, or relevant reminders, news updates, or other types of pro-active interaction. More preferably, these prompts may, for example, also be non-default prompts. For example, the toy may wish to proactively initiate an interaction relating, for example, to items of past conversations (e.g. “Welcome home. How was your ballet class this afternoon?”), or otherwise non-defaulted interaction (e.g. “Hey, John, how's it going?”). The toy may, for example, use predefined moments in time to be proactive, whether these are set by the user, their family members/caregivers, the system itself, or any other way. The toy may also for example use motion detection or a different method to know when a user is nearby so to be proactive, or to decide whether to be so, or for example it may use bluetooth signaling, or wifi signaling, to know, amongst other things, the same.

Preferably, calculations may be shifted in time low-load periods or through other manners to reduce processing costs and/or latency between user input and toy output. For example, proactively (or reactively) output news items and/or other standardized utterances may already be pre-cached (e.g. at lower cost) into ready voice-level sound output, as that may be more cost-effective than transforming text-to-speech to natural voice level afresh every time. Preferably, the news items may comprise, for example, a pre-recorded news bulletin, and/or results from a live web search for news, and/or the user's own personalized news feed (e.g. RSS news items). These may further be combined with any of the interactive media described below herein.

The toy may comprise at least one camera.

Advantageously, the at least one memory of the toy may further store computer instructions configured to cause the toy to recognize a detected person, using the at least one camera, in order to personalize a (proactively initiated or reactive) conversation.

Advantageously, the at least one memory of the toy may further store computer instructions configured to cause the toy to recognize a detected person, through that person's voice, or through some other manner (e.g. face, other biometrics, or otherwise), in order to personalize a (proactively initiated or reactive) conversation.

Advantageously, the toy may leverage a vision model to analyze output of the camera and feed that to the toy providing further context (e.g. what clothing the child is currently wearing, homework, book, and/or other items).

The toy may comprise one or more holograms, holographic effects, and/or holographic illusions (e.g. 3D and other UI or UX designs, multi-screen views, stereoscopic displays, lens light displays, volumetric slices, hologram-like projectors such as for example the known method of pyramids). These (and/or others) may also be especially useful in the context of users who suffer from ADHD, for example, in that the toy may show an image or video of a, for example, actual school mentor. The toy may also use 3D and other UI or UX experiences. The toy may also include holographic illusions, which can be prerecorded or shown real-time: for example, using, for example, a white, or other color, background, certain lighting, and related shadow creations, a user's family, teacher, or other third party, may record themselves (live or otherwise), with said recording live streamed, or shown subsequently, within a rectangular or other box that has 3D effects—for example, due to shading within the box that creates a feeling of depth-giving an illusion of a holographic effect. The recording (live streamed or otherwise) may also be created within a mobile application setting, for example as part of a companion app, with said application containing a camera, with a white, or other color, background, to which a full, partial, or head 3D body image of the user's family, teacher, or other third party, is shown as speaking the words they input, via text, voice or otherwise. The background, and any additional effects, may also be created via computer instructions.

As has already been briefly described hereinabove, the toy may comprise a casing or housing configured to hold all of the electronic (and non-electronic) elements recited in the present disclosure to be comprised by the toy. Preferably, the housing may be specifically adapted for the intended audience, e.g. soft, brightly colored, mutely colored, squishy, fluffy, sturdy, and/or premium, etc. The toy may optionally be integrated in third party casings or devices, such as TVs or devices which include the relevant electronic elements.

The at least one memory of the toy may further store computer instructions configured to cause the toy to be activated (whether the whole toy, the listening function of the toy, or some other function of the toy) upon detecting a wake word spoken by a person, and/or upon detecting a person via voice, image, or video, or other biometrics. The detected person may be identified by recognizing the person's voice pattern or image. Additionally, the toy may include a password protection, where a user may, through audio, share for example a four digit pin code. That input can be processed, checked by the toy if accurate, and if so trigger a further action (e.g. a payment). It may also store computer instructions configured to cause the toy to similarly be activated by a press of a button, whether on the toy or an external button connected wired or wirelessly to the toy, or by, for example, the companion app. Additionally, there may be no need for a wakeword such as where the user engages with the toy, for example by telephone: as soon as the user speaks, the toy knows it must process user input and there is thus no need for a wake-word.

Additionally, or alternatively, a user may be identified through fingerprints when using a press to talk button (e.g. the button can contain a fingerprint scanner, a fingerprint profile can be set up for a user, and an algorithm can seek to match the user's fingerprint with a pre-recorded fingerprint profile).

Additionally, and for all embodiments, in the same way the toy may be always on when waiting to observe the wake word being uttered, its model may similarly be trained to be always on and to detect for example breaking glass, falling person, smoke or other alarm, crying, screaming, yells for help, coughing, etc. or some other sound. Such sound may then trigger the toy to take necessary action (e.g. call emergency services or notify family members). One way to train such a model is similar to the training of it to detect a wake word: rather than a wake word, it would be a predetermined type of noise (e.g. a smoke alarm going off) that would trigger it.

In various embodiments, the at least one memory of the toy may store computer instructions configured to cause the toy to actively forget certain facts, in order, for example, to appear more realistically human. Examples of such facts may include facts that were learned by the ML model a long time ago but that have not been pertinent to any recent conversations with the user, or facts that are potentially embarrassing to the user.

In a further-developed embodiment, the stored computer instructions may be further configured for operating the toy to perform one or more of the following pre-processing steps, after detecting the voice utterance:
transforming the voice utterance into a textual representation using a speech-to-text engine; and
optionally pre-prompting the at least one ML model based on a predefined or dynamic pre-prompting instruction and optionally based on the textual representation.

The voice utterance may then be provided in said textual representation to the at least one ML model, optionally with the pre-prompt.

Suitable speech-to-text engines are available for example as open source engines.

In a further-developed embodiment, the stored computer instructions may be further configured for operating the toy to perform one or more of the following post-processing steps, prior to providing the output to the at least one speaker:
transforming the output from a textual representation to a sound format using a text-to-speech engine or some other process.

Suitable text-to-speech engines are available for example as open source engines.

Advantageously, the text-to-speech engine may be configured to use a particular person's voice profile for transforming the textual representation to the sound format (e.g. so-called voice cloning). This allows, for example, the sale of famous (or infamous) real or fictitious persons' voice profiles, e.g. as an add-on functionality. Additionally, for certain users, such as users suffering from anxiety, the voice of a family member, or other familiar or soothing voice, for example, may be used. Similarly, for example, the child's teacher's voice, child's parent's voice, or (whether fictional or otherwise) child's idol's voice could be used (e.g. a superhero character), for various reasons such as to induce trust, or for familiarity, or entertainment. Additionally, the voice may be different depending on the content or expertise or other element of the conversation with the toy: for example, a chat about astrology may be with the voice of a famous astrologer whilst a conversation about the latest news may be by a famous news anchor whilst a conversation about Cinderella, may be a famous female voice, famous children's book voice-over voice, or that of the Cinderella in a particular representation.

Additionally or alternatively, instead of using speech-to-text and text-to-speech engines, respectively, the system may make use of an end-to-end speech-to-speech ML model, wherein the voice utterance of the user is provided to the at least one ML model directly in speech form, and wherein the output of the at least one ML model is provided to the at least one speaker directly in speech form.

In a further developed embodiment, the at least one ML model may be configured to (also) provide (instructions for generating) a multi-modal output, e.g. an output including images and/or video and/or mouth movements adapted for mimicking a mouth speaking the generated output to be provided to the at least one speaker, and/or sign language adapted for corresponding with the generated output or any other multi-modal output. Additionally or alternatively, such at least one ML model may process multi-modal input.

To reduce latency between user input (a user voice utterance) and toy output (e.g. a toy's voice utterance), numerous approaches may be employed. For example, any one or more of the following approaches can be used: one may use models that are faster than others, one may use models that accept streaming input, one may use models that provide streaming output, one may reduce the code base so to reduce processing steps, one can chunk recordings or streams of voice utterances at optimal times to send to the STT model so to improve the latency between voice utterance and speech to text result, one can chunk LLM output of text at optimal times to send to the TTS model so as to improve the latency between LLM output of text and toy voice utterance and speech, and the like.

Additionally, one can employ user experience solutions to improve the user experience and/or reduce perceived latency. For example, certain sounds can be played or imagery shown, when, for example, the toy is thinking (i.e. processing), or when the toy believes input has ended, and the like. Additionally, for example, one can add a library of filler or other words (e.g. “Hmmm”, “Let me see”, “Got ya”, “Good question”, “Aaah”, etc.) and program the toy so that it plays such a natural filler word immediately, or prior to the toy's speech response, which the user then hears while in the background the full response is being generated. Such a library of pre-created filler or other words can be stored on the toy or in the cloud, and may include a timing logic that estimates when the audio stream of the main output is expected and plays the filler word so that it ends right before the main output is played. Such libraries need not contain only pre-created recordings. Rather, they can be generated by a ML model, and preferably an LLM, as soon as user input is provided to it or at any time. Additionally or alternatively, a ML model, and preferably an LLM model, can be so tweaked, trained, fine-tuned or configured to analyze the input and to, on the basis of the input and expected output, create a natural filler word or words or sentence that is appropriate in the context. Such a filler word, filler words or filler sentence(s) can then quickly be converted into audio and played to the user while the toy at the same time continues to generate the main output.

In addition or alternatively to such filler or similar words, the toy may use the psychology of mirroring techniques (e.g. User: “How are you today?” toy: “How am I today? I am glad you asked, I am great today.”) The benefits of this is that there is less actual and perceived latency, as the user experiences an almost immediate and contextually relevant response (i.e. the mirroring: e.g. “How am I today?”) while the toy generates the rest of the response (e.g. “I am glad you asked, I am great today.”) Additionally, this allows the system to create rapport and demonstrate attention and empathy. Similarly, the toy may provide a response that describes what the toy is doing, particularly for example where the user requests the toy to take an action (e.g. user: “Call Michael”; System “Calling Michael”; or user: “What's the latest news”; toy: “I'm checking the latest news for you.”) This reduces perceived latency in that the user receives relevant and appropriate toy output even before the actual output (e.g. the news) is played, and also may allow the toy to create rapport and demonstrate attention and empathy.

For the avoidance of doubt, this process of using a mirror technique and the other techniques described herein can occur on the toy or in the cloud, and can but need not comprise its own ML model or instructions, and can also run concurrently with other ML models. A simple example of it running concurrently: ML model 1 accepts the input and has clear prompting instructions to simply and only mirror the input, where relevant, in an empathetic manner, whilst ML model 2 concurrently accepts the input and has alternative prompting instructions which prepares a full response to said input. Where output of ML model 1 is ready before output of ML model 2, output of ML model 1 can be played to the user as soon as ready, with output of ML model 2 played subsequently (and can be programmed to play only once the output of ML model 1 has been finished playing so that there is no overlap of audio). Needless to say, ML model 1 and ML model 2 may know of each other's role and work interoperably to provide human-like responses.

The toy may also be configured to use chimes or other audio effects (in addition to, for example, any video, pictorial, and other UI/UX effects) to improve user experience and/or reduce perceived latency. When including said effects, the toy could include these at different relevant stages, such as at every time the mic opens up for listening, or at every time the mic opens up for listening but excluding the time the mic opens up after wake-word usage (so to for example provide a more natural experience: rather than “Hey Rea [toy chime after wake-word as mic opens, and thus pause], how are you?, to “Hey Rea, how are you?” in one utterance). It may also include an effect when the user finishes speaking and starts to await system response, and/or to play a chime when the toy's output ends (so that the user knows that the toy has finished its output). In a proactive setting, where the toy commences communication, the above may also be possible, as well as in three-party conversation and other embodiments.

For the avoidance of doubt, any reference to prompting of an ML model herein, may include prompting through system prompts and/or other prompts.

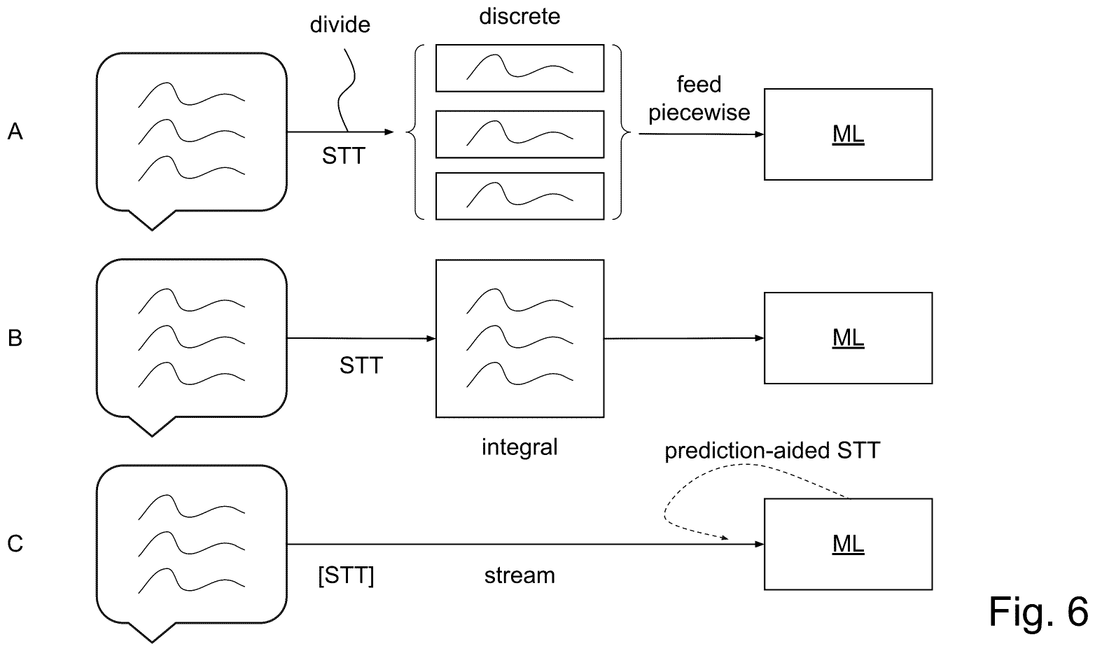

FIG. 6 schematically illustrates several options (A, B and C) of how to provide the voice utterance as input to the at least one ML model in the context of various embodiments according to the present disclosure.

In option A, the voice utterance may be divided by a speech-to-text (STT) engine into discrete utterances, which may be fed piecewise to the at least one ML model, as described elsewhere in the present disclosure.

In option B, the voice utterance may be provided integrally from the STT engine to the at least one ML model. Advantageously, in real-life conversations, voice utterances may be typically short, which means that this integral approach may usually suffice. It also contributes to a benefit of linguistically optimal processing on the part of the at least one ML model.

In option C, the voice utterance may be provided as an ongoing stream to the at least one ML model. Optionally (which is indicated with square brackets and a dashed line), the at least one ML model may be configured to predict one or more likely upcoming elements (e.g. tokens or words) in the voice utterance, based on the stream of the voice utterance that the model(s) has/have so far received. This prediction may preferably be used to aid any STT engine. Of course, it can be foreseen that STT may be dispensed with altogether, and that the voice utterance may be provided to the at least one ML model as a direct speech stream that does not require STT.

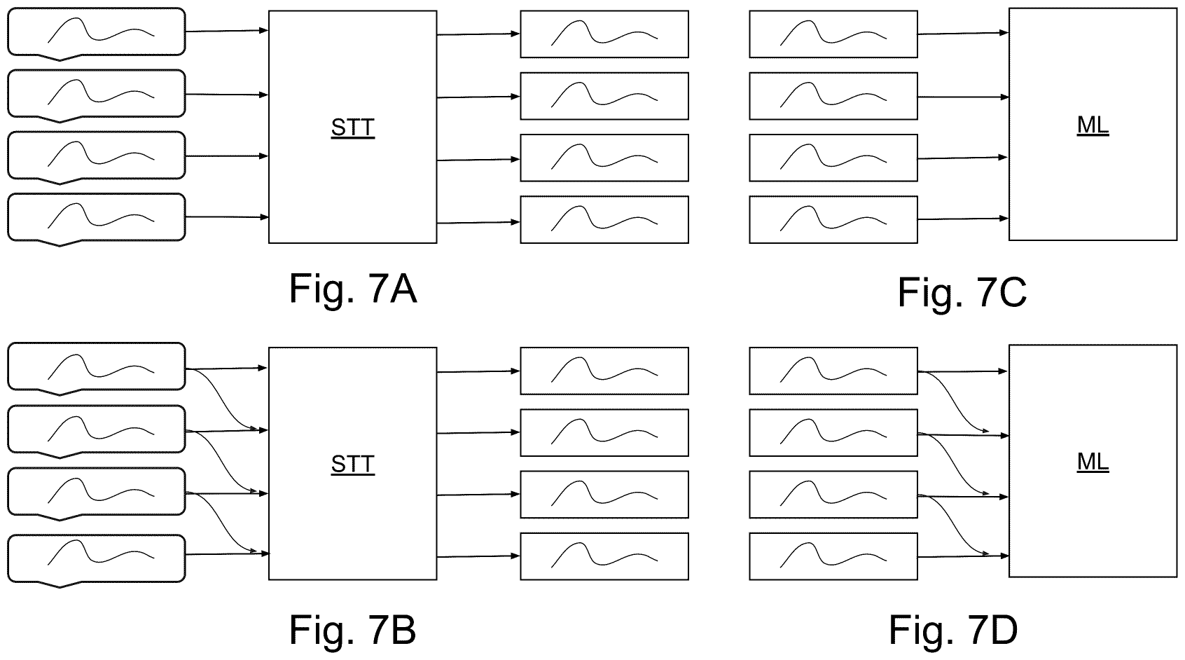

FIG. 7 schematically illustrates several options of transforming the voice utterance into a textual representation (FIGS. 7A and 7B) and several options of providing the voice utterances (in their textual form) as input to the at least one ML model (FIGS. 7C and 7D).

In FIG. 7A, the voice utterances may be transformed from their speech form into a corresponding textual representation individually, using a speech-to-text (STT) engine.

In FIG. 7B, as an alternative, the voice utterances may be transformed from their speech form into a corresponding textual representation using a form of daisy-chaining, wherein at least one previous utterance is also provided to the STT engine along with the current utterance, in order to improve the performance of the STT engine.

In FIG. 7C, the voice utterances in textual representation may be provided to the at least one ML model individually and independently, each triggering an individual and independent inference by the at least one ML model.

In FIG. 7D, as an alternative, the voice utterances in textual representation may be provided to the at least one ML model using a form of daisy-chaining, wherein at least one previous utterance is also provided to the at least one ML model along with the current utterance, in order to enhance the context that is available to the at least one ML model.

### Exemplary Embodiments for People Suffering from Mental Disorders

Various embodiments of the toy may be especially suitable for people suffering from depression, stress, anxiety, bullying, cultural and other disconnection, loss of purpose, loneliness, or other challenges.

The at least one ML model can be prompted, instructed or otherwise fine-tuned or taught to implement, for example, a behavioral activation program (or other CBT or other intervention), and/or other programs with the user. This can be in a formal structured manner, or discreetly as part of day-to-day interactions between the toy and the user. For example, to help children combat self-defeating thoughts, impulsivity, defiance, tantrums and/or to help them to improve their self-image, help them with new coping mechanisms, improve their problem-solving skills, and assist in having more self-control. For example, an LLM model can be provided with guidance on how to run a behavioral activation intervention, for example through instruction, prompting, fine tuning or otherwise trained or configured, which the LLM model can then follow when engaging with the user.

Additionally, a user, family member, nurse or other third party can upload or otherwise share for example exercise, rehabilitation or other instructions (e.g. mental and/or physical exercises), which the toy may process on the back end and, if necessary, extract the text of the uploaded document using common-place OCR or other extraction techniques. That data may then be fed to a ML model, preferably an LLM, which may be instructed, prompted or otherwise trained to guide the user through such exercises and do so through voice. Additionally, the toy may, for example, keep track of adherence (and/or e.g. progression, issues that are raised, and other data) and can, for example, share these data with for example family members, school therapists or others. Additionally, the system can provide memories, encouragement and the like to the user, taking into account the user's adherence. One way the system may track adherence, for example, is through function calling, by adding a separate ML model, preferably an LLM, to monitor adherence, or through other ways.

As noted above, the toy may allow for a user (or e.g. teacher or parent) to upload a document (e.g. a set of exercise instructions), or through voice instruction, or some other method of data input, on the basis of which a text-to-video or speech-to-video engine can, whether or not prompted or otherwise instructed, create a video related to that document or input (e.g. a video showing how the instructions should be followed or undertaken). The toy can then demonstrate that video on the screen when the toy speaks with the user covering content that relates to the video, for example. The video can also be generated continuously and/or in the moment, in light of the conversation. For example, it can generate a video demonstrating the way one solves a math problem in response to a user's query.

Additionally, a camera can be used, with suitable operating instructions, that are adapted to analyze, for example, body movements, to, for example, detect if the exercises (as per the example above) are being undertaken, whether they are being undertaken well, and to further guide the user. Similarly, as another example, to detect, if any, what and what amount of nutrients or nutritions, amount and types of calories, the child is consuming, or analyze a child's homework, to, for example, see if the child has completed the homework correctly.

The toy can also be programmed to provide the user with relevant reminders, such as class reminders, homework reminders, medicine reminders, or any other reminders. As a voice-powered toy, the toy can provide such reminders in an authentic manner, as part of larger conversations or as a standalone interaction, and in any event sound human and personalized (including optionally taking into account user info and conversation context) rather than a dry standard reminder such as an alarm clock of mobile phone reminder.

Additionally, the at least one ML model, may be so prompted, trained, instructed or otherwise fine-tuned or modeled to play games, memory games & quizzes, and/or other games, and/or meditation and/or mindfulness exercises, and/or other memory exercise and training, and optionally to personalize those on the basis of the context (e.g. user information and conversation history described herein). Similarly, it can be so prompted, trained, instructed or otherwise fine-tuned to share education and learning content (whether personalized as above or not). Similarly, the at least one ML model may be so prompted, trained, instructed or otherwise fine-tuned or modeled to play games of any sort. For example, leveraging a camera, the system could play the game often known as “i-spy-with-my-little-eye” with the user, or for example, the fun game known as “Simon says”.

Additionally, the toy can provide the user with music therapy such as by playing certain music, obtaining feedback from the user, and tweaking and/or personalizing the playlist accordingly, with the aim of improving the mental health of the user, for example. Through its conversations and other interactions with user (user information and conversation history described herein) and through the possible further support by integrated feedback mechanisms, surveys, and similar, whether through voice or otherwise, toy may know which music, for example, relaxes or excites user, which music makes user happy, contemplative or similar, for example, and can suggest and/or play the right music at the right time(s) for a specific user(s). Doctor's and/or teacher's instructions (or similar) may also be used in this process of music therapy, as well as any so prompted, trained, instructed or otherwise fine-tuned ML model(s).

Additionally, the toy may provide the user with advice, comment, and/or assistance regarding any aspects of their mental and/or physical health or on any other matter. This can be done for example whenever the child mentions that the child is not feeling well, or if the toy notices (whether via audio, video, pictorially, or otherwise) that the child may be suffering (or starting to suffer, or likely and/or potentially will suffer from) a mental or physical health matter. The toy may do so by asking or otherwise eliciting certain data from the user (via voice, video, pictorially, or otherwise). As an example, acne suffered by some teenagers: acne most commonly develops on an individual's face, and there are 6 main types of spots caused by acne: (i) blackheads, (ii) whiteheads, (iii) papules, (iv) pustules, (v) nodules, and (vi) cysts. If the toy picks up that the child may be suffering from acne (e.g. the user tells the toy that the user is suffering, or the toy sees the spots on the child's face, via the camera, or toy asks, or otherwise converses with user wherein user, for example, describes certain spots on the user's face as for example “small red bumps that feel tender or sore and that have a white tip in the center” (i.e. “pustules”)), the toy will advise the user to for example not to wash the affected areas of skin more than twice a day as frequent washing can irritate the skin and make symptoms worse, and when washing to use mild soap or cleanser and lukewarm water, and to not squeeze the spots. The toy may also advise the user to contact a family member, school, caregiver, doctor, GP, hospital, etc. where necessary, and the toy may also connect the user directly, or otherwise inform or alert relevant stakeholders regarding this. Another example is the common cold. The toy may gather that the user is suffering from certain symptoms such as a blocked or runny nose; a sore throat; headaches; muscle aches; coughs; sneezing; a raised temperature; pressure in their ears and face; and or loss of taste and smell. The toy will gather that these symptoms appeared gradually (as opposed to within a few hours), affects mainly nose and throat (as opposed to other areas), and makes the user feel unwell but still okay and able to continue to carry on as normal (as opposed to too exhausted and too unwell to carry on as normal). In these instances, the toy may identify that the user as suffering from a cold (and not the flu, for example, as the flu appears, for example, within a few hours and affects many more areas), and recommend the user to reach out to doctor, take, or refrain from taking, certain actions, and/or notify the user and relevant stakeholders and databases, and take any other suitable action.

### Exemplary Embodiments for Interactive Media

In a preferred embodiment, the toy may be configured to (e.g. by the at least one memory of the toy further storing computer instructions configured to cause the toy to) provide interactive media, wherein a user can participate, through voice, in what would otherwise be a static experience (e.g. a bedtime story).

A user can interact with the toy and make the conversation dynamic, wherein the at least one ML model can assume, for example, the personas, personalities, character, identity, temperament, background, and/or similar of the characters (e.g. real, fictional or historical) involved in the piece of media, entertainment, storybook, song, or other traditionally static experience, and which may additionally include, for example, the relevant background, qualities, beliefs, personality traits, positions, opinions, prior statements and/or monologues of said characters, and can thus interactively hold a conversation with the user while the ongoing otherwise static piece of media is paused, muted, flows into further conversation with the user, or is otherwise tweaked or changed or otherwise configured, effectively producing a dynamic experience for any piece of media, entertainment, or other traditionally non-conversational experience (e.g. a podcast). This allows the user to, for example, drill down on certain topics and/or move onto others, ask questions, discuss certain ideas and/or topics, etc., with certain characters, holding certain viewpoints, as the at least one ML model can take into account the context, and, amongst other things, the positions and opinions, which may include both those past and present, of characters.

For example, the dynamic experience may relate to, inter alia, any topic in the world, be limited to a single topic only, or otherwise. It may be, for example, a dynamic experience relating to a traditionally live yet static monologue (e.g. a live podcast) such as an audio show that is streamed live to an audience who are listening in real time, or a pre-recorded yet static monologue (e.g. a recorded podcast).

For example, the dynamic experience could relate to an actual traditionally static monologue (e.g. the actual podcast replayed, with the toy being able to interact with the user), or it can be the toy delivering a non-verbatim and/or conversational version of the traditionally static monologue, a mixture of both of the above, create its own interactive experience (e.g. an interactive conversational podcast, which may, for example, be based or founded on, inter alia, the same beliefs, positions, expressions, data, etc., of a certain character and/or on prior podcasts of said character), and/or some other format.

Additionally, and as further examples, the dynamic experience could take the following example formats: (i) the toy commences the podcast, for example, and the user may interrupt the toy, and ask questions or otherwise comment or interact, upon which the toy will interact with the user, and upon finishing this interaction the system may resume the podcast (and may, optionally, make minor tweaks to the podcast text so that it flows naturally from the previous interaction with the user; and which may also include parts of (iii) below), or the podcast may be (somewhat) muted or paused whilst the toy interacts with the user; (ii) the toy interacts in conversation with the user and provides the content (e.g. messages, storyline, key points, etc.) of the podcast to the user in a conversational manner (and which may also include parts of (iii) below), and/or (iii) the toy may have all (or at least some of) the knowledge, character, persona etc. of a podcaster, and interact with the user on any matter relating to the podcasters' most recent podcast, other podcasts, anything else relating to the podcaster or podcaster's podcasts, or anything else.

Referring to the described feature that the toy may be configured to provide interactive media, wherein a user can trigger the toy to, inter alia, pause or stop an ongoing static piece of media and to make the conversation dynamic, it may be preferred to include specific characters (e.g. a princess or a dragon or another fairytale creature), and it may be preferred to also prompt the child for one or more additional story elements.

The toy may have the voice of the character, and may include any expressions, speech patterns and/or similar of the character.

The toy may have a screen allowing the user to have a screen interface and all its benefits.

The toy may have live or static imagery (e.g. photo, video, avatar, or other UI/UX design) of the character, including the character's looks, build, appearance, verbal and non-verbal expressions, manner of speech, and/or similar, and may also, for example, where appropriate, have the right background and similar scene or other settings.

For example, the at least one ML model can be prompted or instructed or otherwise taught or fine-tuned to speak in the style of a children's book character and have for example the context and knowledge of said character and their viewpoints, personality, and persona. Optionally, the toy can take on the voice of the character (and such voice cloning models are available from companies, open-source, or elsewhere). Optionally, the ML model can for example be provided with the text of, for example, a storybook. The toy can then take on that character and start the story. The user can then interject, ask questions, share views, and otherwise steer the direction of the experience-all whilst the toy maintains the persona and the like of the character. Additionally, for example, the scope of diversion of the experience can be set, too (e.g. how far the experience can move from the original scope of the content, for example). For the avoidance of doubt, this can work also in a multi-user setting: for example, a bedtime story told by two storytellers, or more than one child engaging with the toy. As for the latter, see the disclosure herein as regards voice identification and multi-party conversations with the device.

Note, for completeness, that a ML model, preferably an LLM model, can be a model that has been trained specifically for a certain limited task (e.g. tell and discuss a certain collection of children's stories, a single children's story, take on the personality of a character from a children's book) and can but need not be trained using data generated by an LLM model.

### Exemplary Embodiments Featuring a so-Called ‘Conductor’

The at least one ML model may comprise a plurality of ML models, and may also comprise a conductor AI configured to select one or more ML models of said plurality of ML models and further configured to handover the ongoing conversation role to one or more different ML models of said plurality of ML models. Additionally or alternatively, each ML model may be configured to select one or more other ML models of said plurality of ML models and be further configured to handover the ongoing conversation role to one or more different ML models of said plurality of ML models. Additionally or alternatively, and as examples, the user may directly request for, for example, a certain ML model, a certain expert or experts, certain celebrity or celebrities, and/or certain topic or topics. For example, the user may also interact with the toy regarding cooking something for breakfast, and the toy may then get the cooking expert ML on-board or otherwise to interact. Additionally, or alternatively, the toy may include a dedicated ML model for dedicated usage only, e.g. the cooking expert may be the only ML model made available on the dedicated toy, or additional ML models may be added to that toy subsequently, upon top-up purchases, or other determinants.

Preferably, the individual ML models of said plurality of ML models may be configured to assume a persona, personality, expertise, and/or character, whether or not that persona, personality, expertise, and/or character, etc., is directly or indirectly associated with a specific topic, interest, expertise, industry, e.g. music, health, world affairs, cooking, math, history, chess, football, fantasy, etc. The individual ML models of said plurality of ML models may be configured to assume a persona, personality, and/or character associated with a specific person, or non-specific person. It may be configured as a mixture of the above, and may be configured to work hand in hand, and interoperably, with any interactive media, described above. Further, it may interact with, and/or use or otherwise assume or interact as personas, personalities, expertises, and/or characters of social medias, such as instagram, TikTok, Facebook, Youtube, etc., and may work interoperably or hand-in-hand with these, and also more generally with all other third party applications, programs, toys, and/or systems.

In one implementation, each individual ML model may be a distinct model, stored distinctly and runnable distinctly. In another implementation, multiple individual ML models may be different profiles of a same individual ML model, for example based on pre-prompting instructions. Each individual ML model may have a distinct voice, personality, character, memories, knowledge, expertise level, interests, functionality, and may have a different model architecture and/or be differently prompted. Each individual model may also share memories, knowledge, and context. Each model may be configured to share some or all of the context. The user may choose an identity for the expert embodied by the individual ML model (e.g. a specific famous kitchen chef), and may preferably choose experts from a plurality of options. The toy may choose and handover to an expert for the user when applicable, e.g. if the user asks a related question. Each ML model may also be trained, instructed, fine-tuned, prompted or otherwise taught, configured, or told to function in a certain manner, a certain way, for a certain purpose, with a certain aim, or otherwise.

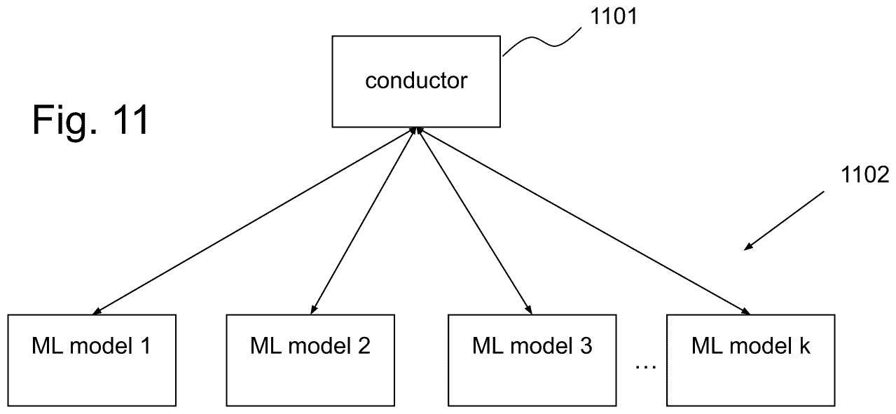

As shown in FIG. 11, an ML model may serve as a so-called conductor 1101 to determine when to pull which other ML model and/or trigger specific prompts or instructions. Such an ML model may be aware of all other ML models 1102 and each of their characters or their respective expertise or knowledge or personality, etc. Such an ML model may be aware of all possible prompts or instructions that may be suitable for adding to instructions to an ML model to address certain user input.

A user may thus, for example, engage with a toy and speak about space, and the ML model that is receiving such input (e.g. ML model 1 in FIG. 11) may then invoke a specific ML model that was, for example, trained to serve as a space scientist tutor (e.g. ML model 3 in FIG. 11) and have that ML model engage with the user. In some embodiments, the user may experience the sense that a different ML model is serving it (e.g. the toy can engage using a certain voice such as that of a famous astronaut).

Example roles/personalities for the ML models 1102 may include, for example: pedagogical assistant, tutor, buddy, caretaker or nurse, gossip friend, personal assistant, professional assistant, romantic interest, pastor or religious leader, digital friend, expert, therapist, coach, etc. Distinct roles/personalities may be embodied by the same ML model, or by a different AI model. Distinct roles/personalities may feature the same voice, or may feature different voices. Distinct roles/personalities may feature the same type of character (e.g. introverted), or may feature different types of character. Distinct roles/personalities may feature the same memory, or may feature different memories, or a mixture of both. Distinct roles/personalities may use different names, for instance, John for math and Jack for cuisine, as well as any other traits, intrinsic or extrinsic.

### Exemplary Embodiments for Religious, Educational, and Other Communities

In a preferred embodiment, the toy may be configured to serve the user as the voice and/or portal of a community. This may be configured in terms of community resources (e.g. what resources does the community provide), information center (e.g. what time does morning services start on Sundays), community courses and education (e.g. coding for beginners, Spanish, or Bible studies, whether interactive, non-interactive, Q&A style of otherwise), community news updates (e.g. John from our community in Springfield just got engaged to his childhood sweetheart from our community), speeches, both live, past, and/or pre-recorded (e.g. sermons from the pastor), community reminders, nudges, and/or (dis-) encouragement (e.g. “Good morning Johnny! Perhaps you would like to join our services this morning, at 9 am”), community advertisements (e.g. “Get 50% off at Community Flower Shop today”), community communications (e.g. between members, or other forms of community communications), community dating (e.g. to introduce members to each other), and other community activities, needs, benefits, desires, etc., and of those of its leaders and/or individual members.

Additionally, or alternatively, the toy may, for example, include an ML model that takes on the character, persona, personality, etc. of the community leader (or multiple ML models for multiple persons), and be endowed with the opinions, beliefs, expertise, etc., of said leader, and with the knowledge of the leader's and community's past community speeches, statements, etc. of said leader and community, as well as endowed with the voice, speech and other speech and character patterns of said leader, thereby allowing the user to interact with the system, and the system with the user, with its related community and other benefits.

### Exemplary Embodiments for a Household, Classrooms, or Similar Multi-User Settings

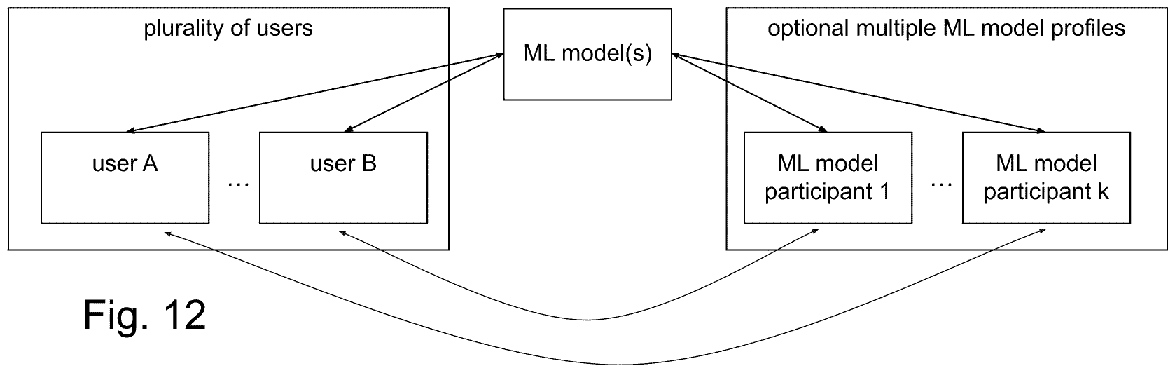

If there are multiple users in a household (or e.g. classrooms), the toy may be able to converse with all of them, as one conversation involving two or more users and of course the toy itself, or involving one or more users and two or more profiles of the ML model(s) making it seem as if there are multiple participants to the conversation that are embodied on the one single toy. Additionally or alternatively, the toy may be able to converse with each household user individually, via an individualized concurrent conversation wherein the toy addresses each user individually without interference (other than some small unavoidable waiting times, if any) from conversations held concurrently with other individual household users, e.g. referring to FIG. 12, if user A asks the toy about topic X while user B asks the toy about topic Y, then the toy may respond to user A about topic X and immediately thereafter may respond to user B about topic Y, and may prepare to detect a new query from user A on topic X in reaction to the toy's response on topic X while also preparing to detect a new query from user B on topic Y in reaction to the system's response on topic Y. The toy may also be able to converse with two or more users at separate times, e.g. for example, the system may interact with user A and then with user B, and may do so as part of the same interaction, or as part of different interactions. The toy may for example pick up that both user A and user B are in the room, for example, as class room, and ask each of them how they are doing, respond to them, individually or together, drive conversation with each, separately or together, similar to the way one would interact with one or more people in a room.

The toy may use the following memory storage options for its at least one memory:
one shared memory for everyone in the household;
one shared memory for everyone and a dedicated memory for each individual; or
a dedicated memory for each individual.

Likewise, the toy may store shared and/or dedicated prompts and/or prompt templates for each individual of the household.

It is preferred to add to every voice utterance a timestamp and an ID identifying the person who uttered the utterance to every voice utterance during processing, to allow the toy to partake in conversations between or involving two or more users concurrently or non-concurrently. One way of enabling a toy with more than one user to have knowledge of which user said what is to add ID labels to each input. One can also add ID labels to each output, labeling which user (or whether to all users) the toy's output was directed.

The toy can be so programed so that the at least one ML model has full context and/or memory of all conversations in that household, only context and/or memory of the conversations with a certain user when it is conversing with said user, or only context and/or memory of some conversations with other users but not all (e.g. only social conversations but not school test results conversations or other conversations of a personal nature, for example).

The user may but need not have the optionality to set the scope of memory when there are more than one users.

User identification by voice, video, image or fingerprint, or some other type of user identification, can be employed to identify which user is engaging with the toy. Similarly, if necessary, such identification can be used the first time when creating a new user profile. Additionally, the toy can be so set that the first time it hears a voice (and optionally the wake word, for example) or sees a new person look at the toy (and optionally for more than X time frame(s)), or for example new fingerprint ID pressing a speak button,) it may, through its voice interface or through some other way, welcome the new user, and/or ask it—for example—for its name, and set up such user's profile, and/or ID, linked to its voice, photo or other identifying mechanism. Similarly, when user A is conversing with the toy, and a new individual commences to interact with the toy (or user A introduces the new individual to the toy, or the toy otherwise notices that a new individual wishes to interact with it or similar), the toy will identify that this new individual is not yet an identified user, will gather the new individual's name and voice identity, will log this, so that going forward when the new individual interacts with the toy, or the toy interacts with the new individual, the toy now identifies the second additional user, with its name and other relevant identifiers (and also relevant memory and/context/and or similar, where appropriate and/or so configured).

Additionally, or alternatively, the toy may, if so configured, identify a new user, as simply Guest 1, and another new user as Guest 2, whilst storing their voice or other identifiers. Further, the toy may if so configured consider any unidentified user as simply Guest, with no identifiers necessarily stored.

Further, the toy may include different wake-words (or other identifying elements, such as a password, statement, etc.) to be assigned to different users (e.g. “Hey Rea” for John; “Dear Rea”, for Susan; “Hey Friend” for Jack), with the toy logging (either prior to toy set up, or subsequently, and whether with or without user input-such as through conversational onboarding, other conversation interaction, a user companion app, or otherwise-which wake-word (or other identifying element) relates to which user, thereby knowing who is interacting, with the toy logging these within system context and similar.

### Exemplary Embodiments for Distributed Operation

The toy may comprise multiple systems and may be configured to operate in a distributed manner over the multiple systems, and may preferably be configured to do so simultaneously. This may work in conjunction with the conductor innovations mentioned above, e.g. where different personas, experts, characters or other ML models are housed in different systems, including in different devices.

Further, the user can have two or more toys, each working interoperably with each other, whether in the same household, class, school, or across the world. Memories may thus, for example, also be shared, as well as for example user profile and other data. In a further embodiment, one main system, can serve as the main toy serving a user, and the user may have pieces of hardware, which may include primarily one or more microphones and/or speakers, which may have less processing power, which may be connected by a communication means to the main toy, for example. This will for example allow the user to interact with the toy in any part of the user's household, irrespective of where the main toy is located.

Further, the toy may always be configured to work interoperably with the user, or it may have the possibility of user log-in at different locations (e.g. the user may identify himself or herself, or the toy may identify the user, for example, via voice, image or video, or User ID or password, identification).

Two or more toys (and their optional companion apps, etc.) may also work interoperably between different users in different households (or e.g. classrooms). For example, User A in household A may have toy A, and User B in household B may have toy B, and toy A and toy B, may share, for example, memories, and/or other functionalities and may work interoperably. Further, the two or more toys can share communication features with each other (e.g. toy at home with toy at school). As another example, user A can use toy A to share a communication with user B's toy B. As an example, User A is the friend of User B, and toy A and toy B are configured to work interoperably. User A may interact and converse with toy A in the usual ways disclosed herein. Further, considering his toy and that of user A's friend are configured to work interoperably, these may be configured to also share memory-whether one shared memory for everyone in the household; or one shared memory for everyone and a dedicated memory for each individual; or a hybrid solution wherein some users may share memories but other users don't. As such, User A may be able to interact with User B's toy in household B. Further, the toys may be able to share information—for example, whether prodded to do so or pro-actively or otherwise—about past conversations, as well as other data picked up by the toy with either, or both of, User A and User B (e.g. past homework assignments and struggles). Further, alerts, messages and similar can be shared between the two or more toys (including via companion apps, text, phone, mobile apps, webapps, emails, etc.), for example, if User A needs homework help a message can be sent to User B's toy. Further, User A may share messages via toy A, or via companion apps, or via text, email, web app, mobile app, phone, fax, etc. or some other method provided to User A, to be shared to User B via toy B, whether these messages are live (e.g. User A is indicating live with User B) or non-live (e.g. User A leaves a voice message that is relayed to User B). The toy may include a message notification signal (e.g. a red flashing light) to alert or otherwise make known to the user, for example, that the toy has a message for them (e.g. whether from a friend, family member, other user, etc.) or that the toy wishes to interact with the user, or for other reasons. The user may then request from the toy to hear said message, or consent or otherwise initiate communication or interaction, verbally or otherwise, to the toy to engage in interaction, or otherwise communicate, or interact, with the toy.

Further, communication, verbal or otherwise, may be configured with other parties too, in addition to or irrespective of a User B and/or a toy B, such as the user's school teacher, for example via a companion app or some other API, and/or any other third parties, users or otherwise. Further, a user may communicate or otherwise interact with the toy (e.g. to text the toy's “brain” i.e. its conversational ML model(s)) via text, whatsapp, email, phone, and/or other methods, as well as allowing the toy to communicate or otherwise interact with the user in these and similar ways (e.g. to communicate, provide reminders, nudges, support, etc.).

Security and privacy considerations may of course be taken into account by the skilled person, with any necessary steps taken to ensure adherence with these considerations.

The user can thus converse with the user's dedicated at least one ML model from any one or more of our toys, or from any toy or toy that includes access to or otherwise operates our systems (e.g. a user may travel the world and stay at a hotel where the hotel has our toy in the hotel room; the user can introduce itself to the toy and go through authentication (e.g. voice and passcode) and then be registered with this toy, which may have relevant context about the user in addition to any hotel or location related information, for example, or for example we may allow the user to use a third party device, such as hotel TV where such device has the requisite electrical elements). The toy may, for example, require some sort of authentication, or User ID, and/or some form of linking to the user's primary, or other, toy.

The toy may comprise a reset function configured for, when activated (for example by pressing a physical or virtual reset button), restoring the toy (in particular: any developed personas relating to and any new knowledge about the user) to factory conditions, or to close-to-factory conditions (e.g. toy is cleared of (some or all) memory, but no need to log in to Wi-Fi again or re-prompt, train, or otherwise configure the system, for example in a hospital, with relevant hospital lunch menu data)) . . . . This is advantageous for distributed setups, wherein privacy must be guaranteed, e.g. after having conversed with the toy over lunch in a café, or after an extended hospital stay.

### Further Embodiments

In an exemplary embodiment, the at least one ML model may have been trained with a corpus predominantly comprising dialogue, whether real or artificial, between at least two parties, wherein at least one party of said at least two parties is a child, or the at least one ML model may be prompted, trained, tuned, instructed, taught or otherwise told, instructed, configured, or arranged to provide its output in a certain way, and/or for example for a certain purpose, whether that purpose or sub-purpose is educational, entertainment, health-related, or otherwise, or to cover a certain topic, whether or not specifically for children, students, or other youngsters. E.g. the at least one ML model can be prompted, trained, tuned, instructed, taught or otherwise told to communicate as a certain princess character, have full knowledge of said princess character's universe, children's books about said character princess, the educational levels, interest, priorities, and objectives of certain or any age groups and/or of individual users within certain or any age group or subset of users or the like, and/or the like.

Further, it may additionally be preferred to include a moderation filtering unit (which may for example be a further development of the above-cited filtering unit) in the toy, in order to improve, for example, or as some baseline of safe language, age-appropriateness, behavior and/or types of speech or interactions towards or with the child. Such a moderation filtering unit may for example be configured for detecting profanity or vulgarity or adult topics and triggering a post-processing step if such topics are detected, and may be configured to interact with a companion app. Relatedly, the toy may also be configured to interact as an early alert system, in cases where child asks for, or otherwise may benefit from for example, emergency help, or where a user mentions thoughts of suicide, self-harm, depression, or similar, or where the toy otherwise picks this, or other matters, up.

It may be preferred to include only a weaker loudspeaker (having only a limited power output that is safe for children) as the at least one speaker, in order to safeguard children's sensitive hearing. Alternatively, if the at least one speaker is capable of outputting with more power, for example if the toy is also shared with other family members who are older children and who may desire powerful sound output, the toy may comprise a volume limiter configured to ensure that sound output respects the limited power output that is safe for children, for example by applying a software-based equalization to any output sound output by the at least one speaker.

In yet other further developed embodiments, the toy may include an interface configured for connecting with a set of headphones, whether wired or wireless, and/or with connectivity to external speakers. In yet other further developed embodiments, the system may include an interface configured for connecting with one or more karaoke microphones, whether wired or wireless, and/or with external speakers.

Furthermore, in a further developed embodiment, the toy may comprise a push-to-talk button configured to activate detection of voice utterances. This has the advantage that there is no continuous need to listen for a wake word, thus saving energy and extending the lifetime of the toy. Of course, in addition to the push-to-talk button, wake word functionality may optionally be provided as well. A wake-word detection algorithm may but need not consist of more than one algorithm whereby an initial algorithm, for example, low power and on device, detects the potential utterance of a wake-word, which then triggers a double check either on the device or in the cloud using a more process heavy processor or through, for example, an LLM that can then confirm whether, on the basis of the input, it seems that the user wants to engage with the system (e.g. reduce false positives). Further, the initial algorithm may be a digital signal processor, which once it is triggered triggers the applications processor to wake up, thereby saving battery life where the toy is powered by battery. Alternatively, or additionally, the wake-word detection can be through transcription of audio input rather than through audio comparison (e.g. the toy can transcribe input and determine when the wake-word has been uttered).

In general, it is preferred to use motion detection (whether through for example a standard motion detection sensor or through photo identification of user, or any other way) for activating the detection of voice utterances. Of course, the toy may be configured to (e.g. by the at least one memory of the toy further storing computer instructions configured to cause the toy to) enter a standby mode after some time of inactivity, e.g. after 1 minute has passed without detecting any voice utterances from the person—in this case, care may be taken to distinguish voice utterances from the person from similar but different sounds from background events.

In yet other further developed embodiments, the toy may comprise at least one input slot configured to receive at least one physical slot token, such as a figurine or a toy card. The toy may be further configured to detect whether or not a suitable and authentic physical slot token is present, in order to unlock all or certain functionality.

In this way, the toy may function as a base platform for which the user (e.g. the child's parent) can buy multiple top-ups that would each give you access to new content or to a new dedicated ML model or persona, topic, purpose, skills, experiences, or characters, and or otherwise for that individual add-on. For example, inserting a princess figurine physical slot token into the input slot may unlock new adventure stories of princesses, or inserting a scientist doll physical slot token may unlock a new Einstein-like persona for the at least one ML model, or inputting a miniature book slot token may unlock a new vocabulary-focused assistant persona, etc.

From a technical perspective, the physical slot tokens may contain a communication interface client element, such as RFID, soundwaves, optical (e.g. infrared), Bluetooth, or Wi-Fi, and the toy may comprise a corresponding communication interface server element configured for detecting the presence of said client element.

Alternatively, it is of course possible to make the toy one-off and stand-alone, meaning that it already offers access to all of its functionality from the moment of initial purchase. Alternatively, it is of course possible to make the offer top-ups that can be activated without the need of using a physical token, such as through an app registered to a user or toy.

Figurines or similar as described above may but need to contain, for example, a microphone and/or speaker with said figurine or similar being connected (e.g. through Bluetooth, wifi, etc.) to the toy whereby for example said figurine or similar may play the output of the toy (which may or may not be individualized for said figurine or similar) and/or serve as providing the input to the toy. Further, each such figurine or similar may have a certain ID, and the toy may know which figurine is providing input/or through which it is providing output and thus may customize such output for the particular figurine or similar.

The at least one AI model may take into account different profile setting, and/or a different knowledge cap (i.e. what the child is supposed to know about and understand), and/or a different language model cap (e.g. to determine whether the at least one ML model should output language using a reduced-difficulty or specialized-topic vocabulary or topic-knowledge specific), which may also improve processing efficiency and reduce time latency in addition to user experience. In a further development, the at least one ML model may be specialized for one specific character and/or use case, which can greatly reduce processing needs, allowing to bring the at least one ML model locally to the toy, resulting in more predictable cost models.

Referring to the above-described feature that the toy may be configured to provide interactive media, the toy may further include such in a fully interactive manner or semi-interactive manner. An example of the latter would be a pre-recorded story, told by the system, where at certain predetermined moments the system reverts back to an interactive process by which it may interact with the user (e.g. “Do you know what this words means?”), before reverting back to the pre-recorded story, thereby saving costs and latency. An at least one ML may assist with this so that when the toy reverts back to the story, it does so in an uninterrupted manner, and seamlessly resumes where the toy left off. Similarly, as another example, when the user barges in, the toy may then revert back to the interactive process, before responding or otherwise interacting with the user and then reverting back to the pre-recorded segments.

The toy may assist the user with the user's homework, assignments, or studies. For example, the user may ask assistance from the toy with the user's math or grammar or history or coding or similar (e.g. “How do I calculate the exact width of my triangle?”, “Am I pronouncing this word correctly?”, “What is 356+356.000”, or “If Liam hires a bike and he has to return it by 3 μm, and the time is now 2:25 pm—how many minutes does he have left?”, or “Why did Nero burn down Rome?”) or other school, educational, or developmental topics, projects, courses, and similar, whether school related or otherwise, for example. The toy may also be more proactive in its assistance (e.g. provide assistance, development, training, and similar, in the absence of a user asking a direct question or for direct assistance).

The toy may assist the user using (whether via uploads, verbal or other input, or otherwise) the user's school (or school-specific) textbook, assignments, tests, programs, course work, goals, etc., as a base of knowledge, structure, or advice, and/or it may for example use any external and/or other sources.

The toy may also serve as a friend. For example, the user may interact with the toy the way a user interacts with their friend. E.g. a user may ask the toy for advice, or confide in the toy, or ask it for help or assistance, etc., and the toy may do the same with the user.

The toy may also explore and develop hobbies and interests of users, and/or after-school style activities or extracurriculars, whether they be playing games, learning or practicing languages, karate, plano, or chess for example.

The toy may also serve as a form of diary. Users tend to write daily diaries, and the toy may assist them with this, and may also serve as a living conversational form of a diary, by discussing and interacting with the user about their day, their highlights, etc. The toy may further then transcribe these into a written diary format for the user, their family, or teachers, etc.

Referring to the above-described feature that the toy may be configured to provide multi-people interaction, this is particularly beneficial in classrooms or other multi-child settings, with the toy conversing with multiple users, and also, beneficially, understanding the unique needs, wants, and/or goals, for example, of each.

Optionally, the toy may further prompt the child for a type of engagement, or the user, their families or other third party stakeholders may otherwise input this into the system: should the dynamic conversation be in any fields, or for example, in one or more specific fields such as the field of science, or education, or fun, etc., and in any more specific areas within these. In this way, the toy may assume a role of, for example, mentor, teacher, private home-school teacher, and/or buddy, depending for example on the wishes and/or needs of the child, teacher, parent, guardian, or school.

The toy may further prompt the child for a type of engagement, or the user, their families or other third party stakeholders may otherwise input this into the toy: should the dynamic conversation be with a focus on a certain development area, for example, the alphabet, vocabulary, grammar, speech, math, history, geography, etc. In this way, the toy may assume a role of, for example, mentor, teacher, or buddy, depending for example on the wishes and/or needs of the child, teacher, parent or guardian.

Optionally, the toy may further prompt the child and/or an adult for a type of engagement: should the dynamic conversation be with a focus on a certain development area, for example, vocabulary, grammar, math, history, etc. In this way, the toy may assume a role of mentor, or buddy, depending for example on the wishes and/or needs of the child, teacher, parent or guardian.

Optionally, the toy may further prompt the child for a type of engagement, or the user, their families or other third party stakeholders may otherwise input this into the system: should the dynamic conversation be with a focus on a certain other area, in terms of inter alia, topic, style, character, etc., for example, anxiety, social awkwardness, how to make friends, depression, ADHD, etc. In this way, the toy may assume a role of, for example, mentor, teacher, or buddy, depending for example on the wishes and/or needs of the child, teacher, parent or guardian.

Optionally, the toy may be limited, through prompting, training or otherwise, and/or through the use of guardrails such as the filtering mechanisms disclosed herein, to a single, some, or some limited types of engagement (e.g. a system only for ADHD-related coaching).

Further, the toy may be designed to assist and interact as regards specific certain topics, or it may be an amalgamation of these, or otherwise. It may also discuss any matter under the sun, or only a certain specific matter (e.g. only about Princess Fiona of Shrek and anything relating to this), only a certain matter but in relation to any matter under the sun (e.g. when talking about football, the system may refer to any science behind it, where science is the specific matter), or in any other way.

It is preferred in embodiments of the toy to configure the speech-to-text engine to accommodate children's developing grammar and speech skills. For example, the speech-to-text engine can be pre-trained, or prompted or otherwise taught to accommodate, amongst other things, children's developing grammar and speech skills. This can be done, where and if necessary, either through prompting of the engine, or fine-tuning of the engine on a corpus of example training data, for example.

In a further developed embodiment of the toy, the toy may comprise limb-like appendages, such as physical toy hands. These can be used not only to improve the liveliness of the toy in the impression of the child, but also to use sign language to communicate the output with deaf or hard hearing children. Further, the toy may include or otherwise be configured to entail any form of robotics (e.g. ranging from moving feet, lips and eyes, to full fledged robotic features).

In a further developed embodiment of the toy adapted for children suffering from autism, the at least one ML model can be prompted, instructed, trained, tuned or otherwise taught or instructed to assist a user suffering from autism. This can be done through, for example, teaching the at least one ML model what its conversations should be so that they are helpful to children suffering from autism. The toy may also help, support, train, educate, or otherwise assist such children in other ways, such as in helping the child with its anxiety, or other mental health, physical health, educational health, and/or to provide autism suitable entertainment, education, and/or other assistance.

In a further developed embodiment of the toy adapted for children suffering from ADHD, the at least one ML model can be prompted, instructed, trained, tuned or otherwise taught or instructed to assist a user suffering from ADHD. This can be done through, for example, teaching the at least one ML model of what its conversations should be so that they are helpful to children suffering from ADHD. The toy may also help, support, train, educate, or otherwise assist such children in other ways, such as in helping the child, for example by training it with (actual or fictitious) conversations between an ADHD child and its therapist.

In a further developed embodiment of the toy adapted for children suffering from inter alia, Dyslexia, Dyscalculia, Dysgraphia, Anxiety Disorders, Depression, OCD, stuttering, apraxia, dysarthria, and language comprehension and expression disorders, intellectual disabilities, down syndrome, anti-social behavior, ODD, eating disorders, PTSD, selective mutism, bipolar disorders, etc., the at least one ML model can be prompted, instructed, trained, tuned or otherwise taught or instructed to assist a user suffering from any of the above. This can be done through, for example, teaching the at least one ML model what its conversations should be so that they are helpful to children suffering from any of the above.

In a further developed embodiment, the at least one ML model can be prompted, instructed, trained, tuned or otherwise taught or instructed to assist a user with their development of inter alia, sensory stimulation, problem-solving skills, hand-eye coordination, fine motor skills, gross motor skills, object permanence, memory and recall, language development, spatial awareness, social skills, emotional development, cause and effect, curiosity and exploration, and similar child development areas. This can be done through, for example, teaching the at least one ML model of what its conversations should be so that they are helpful to children as regards the above, in addition to possible inclusion of hardware (e.g. casing's colors and textures) or other features to assist with the above.

In a further developed embodiment, the interactive AI toy can play an audio book, song, etc., or similar, with no interactivity or conversation allowed, possible, or occurring between user and toy, as well as allowing user to barge in, converse or otherwise interact with toy, or a mixture of the above.

The toy does not necessarily require externally pre-created stories, songs or similar or other audios; it may for example create a story, song, or similar or other audios with the user or for the user, whether prior to, or contemporarily with, usage by the user. Third parties, such as parents, may also create these, prior to or contemporarily with toy interaction, whether via the toy, companion app, or otherwise.

Additionally, or alternatively, the toy may pick up certain emotions of the user, and advise, guide, or otherwise interact to assist the user with these. For example, a child may come home crying, and the toy may pick up the distress of the child and advise the child accordingly (in addition to potentially alerting or otherwise noting this to relevant stakeholders).

Additionally, or alternatively, the toy may serve more generally as a personal assistant to the/a child, and/or the/a grown youngster.

FIG. 1A schematically illustrates an exemplary embodiment 300A of an interactive AI toy according to the present disclosure.

Preferably, the toy 300A comprises a casing (i.e. an outer housing) adapted to the needs and/or desires of the child. In a particular example, shown here in FIG. 1A, the casing of the toy may have the shape of a fluffy toy. In another example, shown in FIG. 1B, the casing of the toy may have the shape of an action figure toy, such as a robot. It will be understood by the skilled person that toy 300B of FIG. 1B may comprise one or more features corresponding with those of toy 300A of FIG. 1A, except as noted herein, and that toy 300B may therefore also comprise one or more microphones 302B, one or more speakers 303B, one or more optional cameras 301B, and one or more optional appendages 304B, as will be explained for FIG. 1A below. Of course, the skilled person will also understand that the toys 300A, 300B may comprise certain internal electronics components, as will be explained hereinbelow with reference to FIG. 2.

The figure shows that the toy 300A comprises at least one microphone 302A, at least one speaker 303A, and optionally at least one camera 301A.

Preferably, the at least one microphone 302A may be positioned within an ear or ear-like element of the toy 300A, to benefit from the association with hearing in order to improve microphone detection potential.

Preferably, the at least one speaker 303A may be positioned within a mouth or mouth-like element of the toy 300A, to benefit from the association with speaking in order to improve speaker directionality potential.

Preferably, the optional at least one camera 301A may be positioned within an eye or eye-like element of the toy 300A, to benefit from the association with sight in order to improve camera detection potential.

The optional at least one camera 301A may further be used, for example, to allow the system to have conversations with people who have speech impediments or who have to (partially) converse with gestures.

Advantageously, the at least one camera 301A may be used to assist the child with, for example, homework or other assignments, by recording, scanning, snapping pictures, or otherwise viewing the child's homework or other assignments, and/or the child's worked-out homework (though there are other methods the toy can follow for this, such as by the user, or third party stakeholder, snapping a picture, and uploading said picture to the toy). The toy 300A may be configured to evaluate these recordings, scans or other such viewings. The toy may then be configured to adapt the at least one ML model to assume a suitable persona for assisting the child with homework, for example by serving as a coach (asking questions like “Did you finish the exercise? Did you think of everything? What about this?” “This is wrong. Please describe how you got this answer.” “This is a better and more accurate method to resolve this.” “Excellent, well done!”), a teacher, or a teacher's support, especially if the at least one AI model has access to hard skills such as mathematics, geography, and/or history, or has otherwise been prompted, taught, trained, tuned, instructed, configured or otherwise been told, or configured, to do so.

Moreover, the at least one memory of the toy may further store computer instructions configured to cause the toy to automatically notify parents of the child on the status of the child's homework, education, and/or general schooling, and extra-curricular progression. For example, the at least one memory of the toy may further store computer instructions configured to cause the toy to generate summaries, alerts, and/or progress reports (on e.g. vocabulary, speech, mathematical prowess, time spent on studying, areas of room for improvements, etc.) and to provide these to one or more designated recipients, e.g. the parents.

Preferably, the toy 300A may comprise limb-like appendages 304A, which may advantageously be integrated with the physical toy hands of the toy system 300A. These appendages 304A may be configured to operate as explained above.

The toy may further comprise an optional display (not shown). The display may be configured to display a visual representation, which may be designed to correspond with the voice utterance output, sign language, avatars, personas of family members or others, or any other displays. This visual representation may for example be generated using a speech-to-face, text-to-video, speech-to-video or multimodal engine.

The visual representation may also provide pre-made videos, or concurrently and newly created video displays, to, for example, assist the user with any matter, or for entertainment purposes, using for example, text-to-video engines. E.g. when assisting the user with grammar or math, or sharing a historical fact or course, or when coaching a child with any physical activities, or when displaying social educational matters, and/or when providing a story or song.

For the avoidance of doubt, the toy in certain embodiments may be able to connect to a server or other component on a separate device, such as for example a smartphone. As such, for example, the toy may be able to leverage a ML model that is on a smartphone and to which the device is connected to, or offload some or all processing to the smartphone, for example.

In various preferred embodiments, the toy may be configured to (e.g. by the at least one memory of the toy storing computer instructions configured to cause the toy to automatically generate and send reports on the health condition (physical and/or mental and/or emotional and/or psychological) of the child to one or more designated recipients, e.g. family members and/or care workers. Preferably, the system may be configured to (e.g. by the computer instructions being further configured to cause the toy to) automatically include information from coupled health systems such as for example a glucose monitoring device.

Moreover, in various preferred embodiments, the at least one memory of the toy may be configured to (e.g. by the at least one memory of the system storing computer instructions configured to cause the toy to notify family members or caregivers, care workers, or others on the user's engagement with the toy and data derived from the user's engagement with the toy. For example, the system may be configured to (e.g. by the at least one memory of the toy storing computer instructions configured to cause the toy to generate, for example, summaries, alerts, and/or progress reports (on e.g. vocabulary, speech, sentiment, etc.) and to provide these to one or more designated recipients, e.g. the family member.

Moreover, one or more ML models may be used to analyze the voice of the user, compare the voice to past stored elements of voice of said user, and to derive insight thereof. Additionally, and for example, one or more ML models or other models can derive insights from analysis of transcripts of the user's conversation with the toy (e.g. on contents, language used, topics discussed, slurring, vocabulary growth, timestamps and time gaps between words, etc.).

The system may be configured to (e.g. by the at least one memory storing computer instructions configured for causing the toy to) remotely monitor the child, using the at least one microphone. Exemplary use cases of such monitoring may include but are not limited to monitoring: heart rate, breathing patterns, and/or movement patterns.

The toy may comprise at least one camera, and the system may be configured to (e.g. by the at least one memory storing computer instructions configured for causing the toy to) monitor the child, using the at least one camera. Exemplary use cases of such monitoring may include but are not limited to monitoring: heart rate, breathing patterns, movement patterns, mood, and/or facial expressions, and/or any other element.

In a preferred further developed embodiment, the toy may comprise or include an algorithm that monitors, measures or otherwise obtains data (e.g. via picture, video, other input or other algorithms) relating to, for example, a user's heart rate, blood-pressure, and/or other vitals or other physical or mental states. The toy may additionally analyze any textual or other data obtained from the user, to delve into, for example, the topic or other context that caused or is related or has some other association with for example a spike in the user's blood pressure. The inverse is also possible, in that the toy may analyze any vitals data to delve into the topic or other context.

Further, in a preferred further developed embodiment, the toy may comprise an early detection of issues, whether physically, mentally, or otherwise, that affects or may affect a user. For example, the toy may notice (or otherwise be told or otherwise insinuated to, by a user) that the user is sad, depressed, lonely, lacking (healthy) food, tired and lacking sleep, or not sleeping well, etc. The inverse is also possible, the toy may notice positive aspects relating to a user, such as a user being happy. Further, health differences between different times may also be picked up by the toy, such as the user being happier than the day before. The toy may also notice aspects of user's life that user is worried about or excited about, as another two examples, of the toy picking important and helpful information that could benefit the user, the toy itself, the user's family members, caregivers, and other stakeholders, and such information may be transmitted to the user or other stakeholders.

Advantageously, the toy may be configured to (e.g. by the at least one memory of the toy storing computer instructions configured to cause the toy to periodically ask the user whether they have complied with specific health prescriptions (e.g. taking vitamins, minding nutrition and hydration, etc.) and/or to encourage, remind and/or otherwise assist a user regarding these), in the form of a voice conversation interaction. This enables the toy to be used inter alia for self-management of chronic diseases and disabilities by the user. Additionally, the toy may provide such reminders and nudges in a human-like manner as part of its conversations with the user, and, moreover, but not required, the toy can use empathetic and other vocabulary and voice intonations when reminding the user. This is advantageous, compared to standard alarm-like reminders. Additionally or alternatively, one or more ML models or other models may be employed to test or analyze what language, what time and/or in any other circumstances reminders have tended to be acted upon and when they have not been acted upon (e.g. the toy can ask the user, track, or get this data some other way). Additionally, the system may leverage such insights on language, time, and/or any other circumstances so as to tailor its reminders to that user in a manner that makes the user most likely to follow its reminders. Additionally, this can be employed not only for reminders but for all forms of nudges, such as exercise, nutrition (e.g. glucose intake), social and other reminders or nudges.

Additionally or alternatively, the toy may be configured to (e.g. by the at least one memory of the toy storing computer instructions configured to cause the toy to trigger an intervention from a designated or default caregiver, teacher, or responder, based on said monitoring, in particular if a health parameter value reaches or threatens to reach a danger criterion (e.g. no breathing sound is being registered for a predefined number of seconds, or the child's response appear to be slower or less cohesive than usual), and/or if an environment parameter value meets a danger criterion (e.g. a sound of breaking glass).

In this context, and as regard all references to video or photo or camera data herein, the skilled person may decide on a tradeoff between using video data and using single image frames for said monitoring. Of course, video data contains more information than do single frames, but the processing power (and hence time lag and energy expenditure) are much higher for video data than for single frames. Preferably, the at least one memory of the toy may further store computer instructions configured to cause the toy to use only single frames if a task is deemed time-critical and/or if a battery status does not satisfy a predefined threshold condition.

The at least one camera may e.g. be activated using an individual spoken command, using a fixed timing (e.g. daily at 11:00, or hourly, or every minute, or every second), and/or with a button press.

Additionally or alternatively, the toy may be configured to (e.g. by the at least one memory of the toy storing computer instructions configured to cause the toy to) trigger an intervention from a designated or default caregiver or responder when the user so requests (e.g. a cry for help).

In some embodiments, the toy may be configured to (e.g. by the at least one memory storing computer instructions configured for causing the toy to) notify the child's reaction to receiving a notification from a family member or friend that said family member or friend is thinking sympathetically of the child or sharing some other message with said the child.

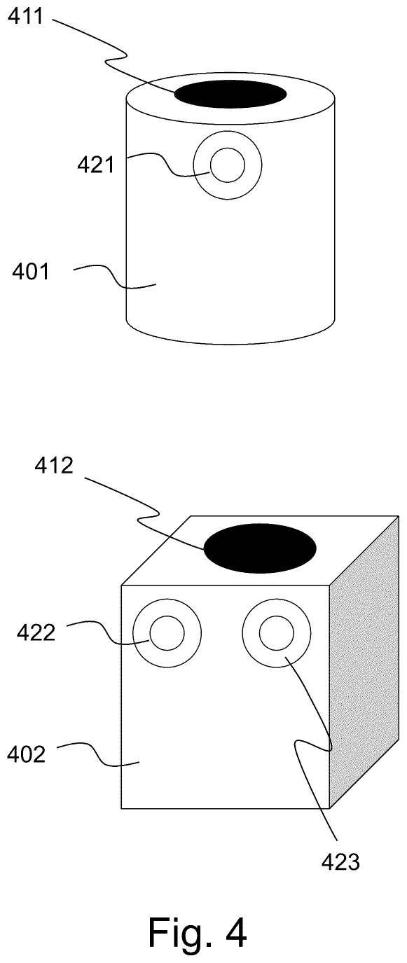

FIG. 4 schematically illustrates two exemplary embodiments 401, 402 of an interactive AI toy according to the present disclosure.

The figure shows that the first embodiment 401 of the toy comprises at least one speaker 411, and at least one microphone 421.

Preferably, the at least one speaker 411 is positioned in a way that allows its sound output to reach the child even if the child is far, e.g. on top of the toy 401.

Preferably, the at least one microphone 421 is positioned in a way that allows it to detect voice utterances of the child, e.g. on the side of the toy 401, to capture incoming sound as directly as possible.

The figure further shows that the second embodiment 402 of the toy also comprises at least one speaker 412, and at least one microphone 422, and additionally comprises at least one camera 423, as explained above.

Preferably, the at least one camera 423 is positioned in a way that allows it to capture as much of the environment as possible, including the child, e.g. on the side of the toy 401.

The optional at least one camera 423 may further be used to allow the toy to have conversations with children who have speech impediments or who have to (partially) converse with gestures.

### Exemplary Embodiments for Personalized Advertisements and Leads

In a preferred embodiment, the toy may be configured to provide advertisements to users on behalf of third party services and/or companies as well as on behalf of the toy's own company, services, and/or features. These may, for example, be pre-recorded, or concurrently created, via prompting, training or otherwise, by the toy, via a different method or a mixture of these, and may be personalized for a user, user requirements, needs, desires, and/or other context. Further, these adverts may take the form of interactive media, described above, allowing a user, for example, to interact with the advertisement, and/or, for example, ask questions or delve into the topic and/or company advertised.

In a further preferred embodiment, the toy may provide leads to, and/or advertisements for, third party services and/or companies, in various ways, such as, for example, in conversations where appropriate or applicable, when user input or toy output otherwise relates to it, or at predetermined moments. The toy may also choose to do so only for pre-vetted, or otherwise more reputational leads, and may further use self-vetting, or pre-vetted or pre-ranked by the system, or according to a dedicated database we set up, and/or ranking, and/or online searches and/or online review databases such as Tripadvisor and similar to do so. These recommendations and leads may also be personalized to the user and surrounding context.

### Exercise Videos

In an embodiment, an optional display may be used for displaying exercise or other videos. The toy may be configured (e.g. by containing in the at least one memory computer instructions for) causing the at least one ML model to generate one or more exercise or other videos in order to accompany or even replace a linguistic or formal description of an exercise regimen e.g. a regimen prescribed by a medical doctor or a physical therapist or something else. Similarly as regards any other sort of program, or actionable or other items, topics, or advice where the user can benefit from a visual description or vision, for example as regards nutrition, sleep, etc.

The toy may also include methods to see whether the user is following the instructions the way the user is supposed to, by using for example the optional camera.

### Exemplary Embodiments for an Application-Style Marketplace

In an exemplary embodiment, the toy may comprise an application portal, primarily voice-powered, to assist or otherwise serve the user. For example, a user may be interested in purchasing certain “apps” that serve the user and that can be accessed through the system, whether that be, for example, games (e.g. bingo, or i-spy), services (e.g., tutoring services), entertainment (e.g. stories, music), and these may be purchased through the toy and then accessed through the toy. The provider of such services may be us, third party partners and/or vendors.

Access to such “apps” may be granted to a user complimentary or at charge.

When charging a user, or in any other situation where the toy needs to verify a user, the toy can do so through voice profile (i.e. match voice to already set up voice profile), secret password (i.e. match password to already set up password), and/or other methods.

### Exemplary Embodiments for Multi-Faceted Ecosystem

In an exemplary embodiment, the toy may comprise a full holistic voice-powered portal to assist or otherwise serve the user. This includes, for example, services and/or features that assist the user with their social lives (e.g. conversation, social support, advice, recommendations, assistance, etc.), entertainment (e.g. conversation, radio shows, music, interactive media, etc.), mental, physical and other care and/or daily living assistance (e.g. exercise), and/or specialty care (e.g. ADHD). The toy may also include features and/or services that assist or otherwise serve family members and/or other stakeholders (e.g. schools). The toy may also include features and/or services that assist or otherwise serve users as their AI agents (e.g. order an Uber or other taxi, arrange their shopping, send texts, emails, and similar, etc.). For example, a user can express their desire to have a car pick them up and take them to a certain location; the toy can then trigger on the back end and schedule a car to pick them up (whether via API to a cab service or ridesharing company, or whether through a different manner). The toy may also include features and/or services that assist or otherwise serve the user as a form of AI service provider. For example, as described above herein, the toy may provide initial and/or more substantial medical advice, diagnosis, and similar, serving for example as a form of an ADHD counselor, and it may do so all through a voice powered interface. Further, the toy may assist and/or otherwise serve the user by being connected with an entire ecosystem of proprietary and/or third party services.

### Exemplary Embodiment for Sleep and Bedwetting

In an exemplary embodiment, the toy may contain or otherwise have access to at least one ML model, preferably an LLM model, that has been so trained, instructed, configured, prompted, or otherwise taught to take a child through the process of learning to use the restroom rather than wetting themselves, whether at night or during the day. Additionally, the toy through its context (and memory) may keep track of the child's patterns, performance and progression, and in light of these provide the suitable and appropriate assistance and/or training to the child (e.g. encourage the child to go to the restroom before sleep). The toy may also keep parents updated and use input from parents when training or assisting the child.

In an exemplary embodiment, the toy may be so trained, instructed, configured, prompted, or otherwise taught to assist users with their sleep. For example, toy may include monitors and other methods that, could track the user's sleep and sleep patterns using different methods, such as motion detectors or “nearables” (e.g. as opposed to, or in addition to, wearables) which are systems placed nearby the user. The toy may assist with bedtime and waketime routines. The toy may encourage healthier, or better, bedtime and waketime routines, such as, for example, encouraging no screen time, encouraging and assisting with better nutrition, or through, for example, reading a story or singing a song. The toy may also assist the user with stress and depression issues through coaching, advice, and/or other methods. Further, the toy can provide speech-to-speech, cognitive behavioral therapy (CBT) to improve relaxation and sleep.

### Pre-Caching

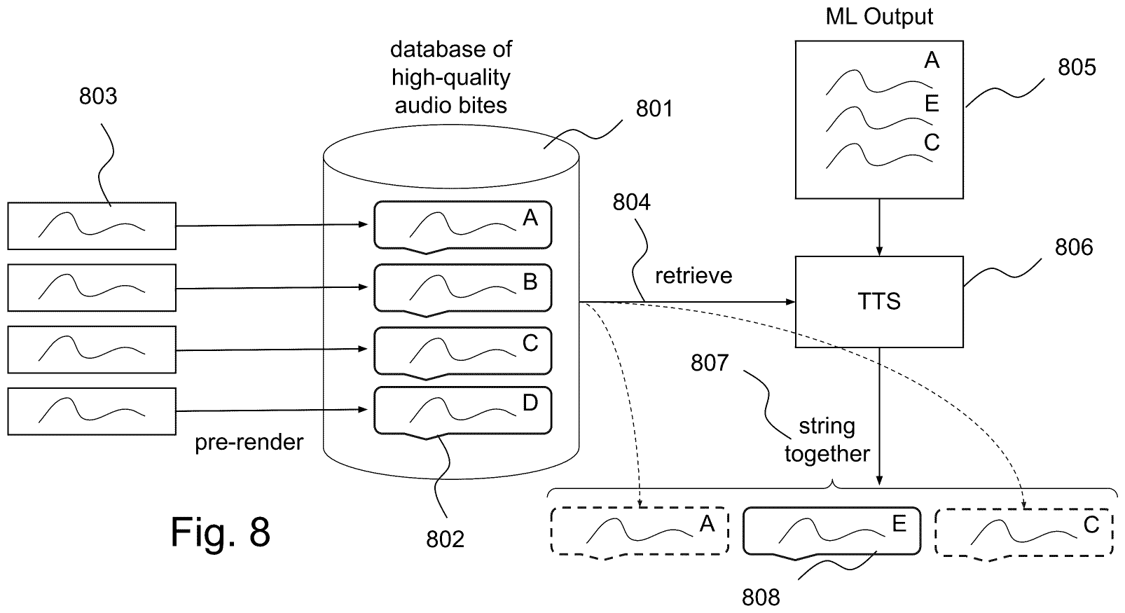

In various preferred embodiments of the toy, the at least one memory may comprise a database 801 (referring e.g. to FIG. 8) of precached high-quality (i.e. human voice quality) sound snippets 802, preferably containing a plethora (e.g. several hundred to several tens of thousands) of frequently used words and/or expressions pre-rendered to a high sound quality, and preferably including multiple pre-rendered intonations for some, preferably all of those words/expressions (e.g. intonations indicating statement, question, exclamation, etc.).

This feature of rendering and storing sound elements to a high quality ahead of time, may in a single term be called ‘precaching’. Advantageously, the direct output of a precached word or expression can be sped up tremendously, as there is no need to first transform said word using a text-to-speech engine. Moreover, to even further advantage, rendering a longer string of words and/or expressions (e.g. a full clause or sentence) to human voice quality may be expensive computationally (particularly if it has to be rendered anew every time), but by precaching at least some of the constituent words/expressions of common or likely clauses/sentences, it is made possible to only have to compute the harmonization across words/expressions, which can be more easily feasible in real time. Thus, the toy may be optimized for seamlessly real time human voice quality sound output.

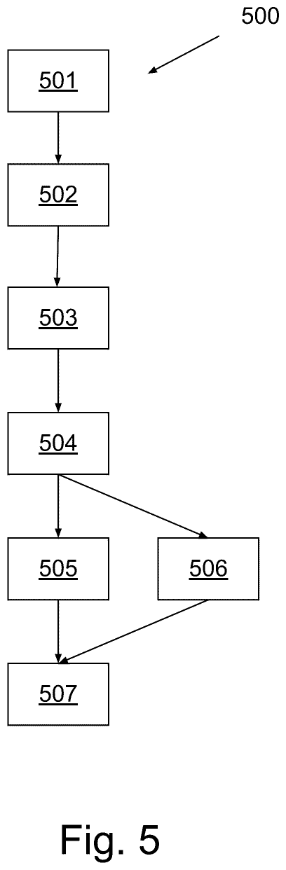

FIG. 5 schematically illustrates an example approach to said pre-caching.

The figure shows the following steps, which may be added to any method embodiment described herein:

In step 501, a set 803 of common and/or likely words and/or expressions may be determined, e.g. based on frequency tables of everyday language data (e.g. news reports, chat files, conversation transcripts, etc.) or of specialized language data (e.g. history books, fairy tales, etc.).

In step 502, the determined set 803 of common and/or likely words and/or expressions may be pre-rendered to a high sound quality, e.g. to a sound level that is indistinguishable from true human voice output. This step may be computationally expensive, so it is preferred to perform this step ahead of time. If the toy is intended for standalone operation only and does not include any suitable communication interface, this step may be performed prior to finalization of production of the toy. If the toy is intended to operate via a communication interface (e.g. to send requests and receive responses from a server, or to be updated by a server), this step may alternatively or additionally be performed after finalization of production of the toy, in the sense that the available words/expressions may be (further) updated after the toy is already ready for operation.

In step 503, the pre-rendered set 802 of common and/or likely words and/or expressions may be stored locally in a database 801 in the at least one memory of the toy, and/or may be stored remotely in a database of a server with which the toy may be configured to communicate.

In step 504, the at least one processor of the toy may execute computer instructions stored on the at least one memory and configured for causing the toy to detect whether or not any words and/or expressions in an output 805 received in textual representation from the at least one ML model are contained within, or are substitutable by any words and/or expressions within, the (local and/or remote) database.

In step 505, the at least one processor of the toy may execute computer instructions stored on the at least one memory and configured for causing the toy to obtain 804 pre-rendered instances 802 of the detected words and/or expressions from the database 801.

In step 506, the at least one processor of the toy may execute computer instructions stored on the at least one memory and configured for causing the toy to render freshly 808 any words and/or expressions that were either absent from the database 801 or that could not be suitably substituted by anything from the database 801.

Preferably, step 506 may be performed concurrently (i.e. simultaneously) with step 505, in order to save overall processing time, because after step 504, the toy can know about which words and/or expressions were either absent from the database 801 or could not be suitably substituted by anything from the database 8021.

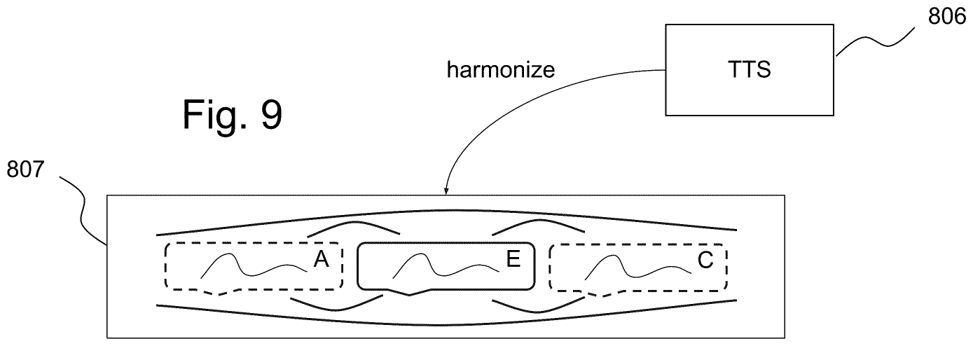

In step 507, the at least one processor of the toy may execute computer instructions stored on the at least one memory and configured for causing the toy to compute 806 sound output configured to link or string 807 together any of the pre-rendered instances with any that have to be freshly rendered 808, in an auditorily harmonious and seamless manner (see also FIG. 9). The computer instructions may also, but need not, be configured for causing the toy to start playing part of the response to the user while it is still computing the remainder of the response as per the steps above.

The result of this approach is that harmonized human voice level output can be obtained in a computationally efficient manner.

It is noted in general that, where an embodiment of the interactive AI toy according to the present disclosure is described as being configured for a particular action, the skilled person may of course understand this to mean that there are computer instructions on the toy (i.e. stored in the at least one memory of the toy), which computer instructions are specifically configured for that particular action (i.e. to cause the toy to perform that particular action). By extension, the skilled person will appreciate that, whenever in the present disclosure it is disclosed for any embodiment that the at least one memory stores computer instructions configured for causing the toy to perform a particular action (or similar wording), this may mean that various embodiments of the method according to the present disclosure may comprise a step of actually performing that particular action. Vice versa, the skilled person will appreciate that, whenever in the present disclosure it is disclosed for any embodiment that the method comprises a particular step, this may mean that various embodiments of the toy according to the present disclosure may be arranged such that the at least one memory stores computer instructions configured for causing the toy to perform that particular action.

Likewise, it is also noted in general that, where an embodiment of the interactive AI toy according to the present disclosure is described as comprising a certain module or unit or the like, having a specific functionality, the skilled person may of course understand this to imply that there may be computer instructions on the toy (i.e. stored in the at least one memory of the toy), which computer instructions are specifically configured for that specific functionality (i.e. to cause the toy to perform that specific functionality). By extension, the skilled person will appreciate that, whenever in the present disclosure it is disclosed for any embodiment that the at least one memory stores computer instructions configured for causing the toy to perform a particular action (or similar wording), this may mean that various embodiments of the toy according to the present disclosure may comprise corresponding functional units or modules or the like, and that these may be implemented as a stand-alone unit within the toy, or as an integral part of the hardware and/or software of the toy.

As used in this application and in the claims, the singular forms “a,” “an,” and “the” include the plural forms unless the context clearly dictates otherwise. The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “obtaining” and “outputting” to describe the disclosed methods. These terms are high-level abstractions of the actual operations that are performed. The actual operations that correspond to these terms will vary depending on the particular implementation and are readily discernible by the skilled person.

It will be appreciated that for simplicity and clarity of illustration, where appropriate, reference numerals may have been repeated among the different figures to indicate corresponding or analogous elements. In addition, numerous specific details are set forth in order to provide a thorough understanding of the examples described herein. However, it will be understood by the skilled person that the examples described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the examples described herein.

Of course, the skilled person will understand that the present invention may be implemented in other ways than those specifically set forth herein without departing from the essential characteristics of the invention. The embodiments described herein are thus to be considered in all respects as illustrative and not restrictive, and all changes within the scope of the appended claims are intended to be embraced therein.

1. An interactive artificial intelligence (AI) toy (300A, 300B) capable of holding a spoken conversation with a person; the toy comprising:
at least one microphone (302A, 302B) configured to detect a voice utterance of the person;
at least one speaker (303A, 303B) configured to output a sound to the person;
at least one processor (111) configured to execute computer instructions; and
at least one memory (112) storing computer instructions configured for operating the toy to perform the following steps:
providing (201) at least one machine learning (ML) model configured for generating contextually relevant and varied responses in natural language conversations, by:
loading the at least one ML model into the at least one memory from an optional storage medium (113) storing the at least one ML model; and/or
connecting via an optional communication connection (126) of the toy with a server (115) providing a conversation interface to the at least one ML model;
detecting (202) a voice utterance of the person using the at least one microphone;
providing (203) the voice utterance as an input to the at least one ML model;
prompting (204) the at least one ML model to generate an output based on based on the input; and
providing (205) the output to the at least one speaker to be output to the person.

2. The toy of claim 1, wherein the at least one ML model comprises:
a Natural Language Understanding (NLU) module for parsing a user input;
a Context Management (CM) module for maintaining a conversation context; and
a Generative Language (GL) module for producing coherent responses based on the input and the context.

3. The toy of claim 2, wherein the CM module is configured to receive any or all previous conversations between the system and the person.

4. The toy of claim 1, wherein the steps further comprise:
detecting whether a suitable and authentic physical token is present to unlock at least one toy function for one or more users.

5. The toy of claim 4, comprising at least one input element configured to receive the physical token.

6. The toy of claim 4, further comprising:
a wireless communication interface configured to detect a presence of and/or a distance to a corresponding wireless communication element contained in the physical token.

7. The toy of claim 1, comprising a wireless communication interface configured to establish a connection to a top-up server; wherein the steps further include:
receiving, from the top-up server, a verified indication indicating at least one toy function to be unlocked for one or more users; and
unlocking the indicated at least one toy function.

8. The toy of claim 1, wherein, the steps further include:
after detecting the voice utterance, transforming the voice utterance into a textual representation using a speech-to-text engine;
wherein the textual representation of the voice utterance is provided as the input to the one or more ML models.

9. The toy of claim 1, wherein the steps further comprise pre-prompting the at least one ML model based on a predefined or dynamic pre-prompting instruction.

10. The toy of claim 1, wherein, the steps further comprise, prior to providing the output to the at least one speaker:
transforming the output from a textual representation into a sound format using a text-to-speech engine.

11. A computer-implemented interactive AI toy method (200) for holding a spoken conversation with a person, comprising:
providing (201) at least one machine learning (ML) model configured for generating contextually relevant and varied responses in natural language conversations by:
loading the at least one ML model into the at least one memory from a storage medium (113) storing the at least one ML model; and/or
connecting, via a communication connection (126) of the toy, with a server (115) providing a conversation interface to the at least one ML model;
detecting (202) a voice utterance of a person using the at least one microphone (101) of a toy;
providing (203) the voice utterance as an input to the at least one ML model;
prompting (204) the at least one ML model to generate an output based on the input; and
outputting (205) the output to the person using the at least one speaker (102) of the toy.

12. The method of claim 11, wherein the at least one ML model comprises:
a Natural Language Understanding (NLU) module for parsing a user input;
a Context Management (CM) module for maintaining a conversation context; and
a Generative Language (GL) module for producing coherent responses based on the input and the context.

13. The method of claim 12, wherein the CM module is configured to receive any or all previous conversations between the system and the person.

14. The method of claim 11, further comprising:
detecting whether a suitable and authentic physical token is present, in order to unlock at least one toy function for one or more users.

15. The method of claim 14, wherein the toy comprises at least one input element configured to receive the physical token.

16. The method of claim 15, further comprising:
a wireless communication interface, a presence of and/or a distance to a corresponding wireless communication element contained in the at least one physical token to be received.

17. The method of claim 11, comprising a wireless communication interface configured to establish a connection to a top-up server, wherein the steps further include:
receiving, from the top-up server, a verified indication indicating at least one toy function to be unlocked for one or more users; and
unlocking the indicated at least one toy function.

18. The method of claim 11, further comprising:
after detecting the voice utterance, transforming the voice utterance into a textual representation using a speech-to-text engine, wherein the textual representation of the voice utterance is provided as the input to the one or more ML models.

19. The method of claim 11, further comprising:
pre-prompting the at least one ML model based on a predefined or dynamic pre-prompting instruction.

20. The method of claim 11, further comprising:
prior to providing the input to the at least one speaker, transforming the output from a textual representation to a sound format using a text-to-speech engine.

21. A computer program comprising instructions which, when the program is executed by a computer, cause the computer to carry out the method of claim 11.
